(19) United States
(12) Patent Application Publication
(10) Pub. No.: US 2015/0066949 A1
(43) Pub. Date: Mar. 5, 2015

(54) COMPUTERIZED SYSTEMS AND METHODS FOR SOCIAL NETWORKING

(71) Applicant: BLOOMBERG FINANCE L.P., New York, NY (US)

(72) Inventor: Robert HARLES, Chicago, IL (US)

(73) Assignee: BLOOMBERG FINANCE L.P., New York, NY (US)

(21) Appl. No.: 14/016,767

(22) Filed: Sep. 3, 2013

(51) Int. Cl. G06F 17/30

(52) U.S. Cl. CPC G06F 17/3053
USPC 707/748

(57) ABSTRACT

A social networking system according to an embodiment of the invention may gather, manage, and order information, such as users' posts. Posts may be organized in objects called “streams” or “currents”, and users may discuss streams, posts, and/or other discussions. The system may keep track of users' actions, and use these actions to score, e.g., posts, streams, discussions, and/or users. In embodiments of the invention, these scores may be used, e.g., for rankings, and these rankings may be used, e.g., to recommend posts, streams, discussions, and/or users to users of the system.

### COPYRIGHT NOTICE

A portion of the disclosure of this patent document contains material that is subject to copyright protection. The copyright owner has no objection to the facsimile reproduction by anyone of the patent document or the patent disclosure as it appears in the Patent and Trademark Office patent files or records but otherwise reserves all copyrights whatsoever.

### BACKGROUND

The Internet makes an immense amount of information, including news and analysis, available in an instant, and the volume of information continues to grow explosively. Paradoxically, however, the sheer amount of information may keep users from finding items that they would find most useful. And although there are ways to filter this flood of information, they have proliferated as well, leading to the second-order problem of finding reliable guides to information on the Internet.

### BRIEF SUMMARY OF THE INVENTION

Embodiments of the invention relate to using computer networks to distribute information, such as articles and commentary. More specifically, embodiments of the invention include computerized systems and methods for creating and posting content to make it available to other users. Examples of such items of content may include, for example, news reports, news analyses, essays, and comments. User-posted items of content may according to embodiments of the invention embed or link, e.g., to other Web pages or other content. Users may see and comment upon others' posts.

A Web site according to an embodiment of the invention may select and organize user-submitted content based on measures of its overall relevance to users. According to embodiments of the invention, users may, for example: share content that they have discovered online with other similar-minded site members; follow content, viewing the most relevant items in a category sorted by recent popularity, topical relevance, and/or other weighted measurements; identify and follow other users who share specific interests; and/or identify and follow other users who have a history of providing relevant content. To encourage users to post interesting content and/or to find interesting content and/or users who provide it, a Web site according to an embodiment of the invention may use strategies such as “gamification”, e.g., by awarding points to content or users when specific interactions occur on the site.

According to an embodiment of the invention, posts may be organized using objects called “streams”. (In connection with embodiments of the invention, including embodiments depicted in this application's figures, a stream may alternatively be referred to as a “current”) A user may create a stream, and then items may be assigned to one or more streams at the time of posting. The stream may be assigned to one of a number of top-level topics and may be regarded as a user-created subtopic beneath its respective topic.

Users may in embodiments of the invention have several options for how they find and view posts. For example, according to an embodiment of the invention, a user may choose to follow one or more of: topics, streams, and other users. A user may then see new posts under a followed topic, stream, or user, e.g., by visiting the site and logging in. A user may also choose to receive alerts, e.g., in the form of email messages that list and/or summarize recent posts from followed users or in followed topics or streams.

Embodiments of the invention may include rankings or ratings of some or all objects or types of objects, including one or more of: posts, streams, users, and topics. For example, in an embodiment of the invention, posts, streams, and users may all be subject to a rating system, and such a system may help identify the posts that users may find most useful (e.g., relevant, interesting, newsworthy, insightful, etc.).

According to one rating system, in an embodiment of the invention, posts, streams, and/or users may receive points as people use the system. For example, a post may receive points each time any user retrieves it. Posts may then be ranked in order of their relative numbers of points. A stream may be rated according to the sum of the views of the posts that it contains, and a user may be rated according to the number of views of the user's posts, the number of views in streams that the user created, or both. In addition to this kind of rating, or instead of it, posts, streams, and/or users may be ranked according to whether they are “trending”, which may reflect recent changes in popularity.

According to an embodiment of the invention, a method of providing information is performed by a networked computer system that comprises one or more processors, one or more interfaces operatively coupled to one or more of the processors, and one or more databases operatively coupled to one or more of the processors. The method comprises storing in the database information that represents a plurality of streams, information that represents a plurality of posts, and, for each post, information that specifically associates that post respectively with at least one of the streams. The method also comprises receiving through at least one of the interfaces first user input that corresponds to a first plurality of actions, performed by at least one user, with regard to the plurality of posts.

According to the method, at least one of the processors executes instructions to calculate, for each of the streams, a score for the stream based upon the first user input and, for each stream, stores the respective score for that stream in the database in association with the stream. At least one of the processors calculates an ordering for a plurality of the streams based on the scores of the streams. The method also comprises transmitting through at least one of the interfaces information that indicates the ordering.

According to an embodiment of the invention, each of the first plurality of actions is an action from the group that consists of: creating the post, sharing the post via social media, following a hyperlink within the post, adding a new comment to the post, and adding the post to a new stream.

According embodiments of the invention, the method may comprise receiving through at least one of the interfaces second user input corresponding to a second plurality of actions, performed by at least one user, with regard to the plurality of streams. In such embodiments, the calculated score for each stream may be based on the first user input and the second user input.

According to some such embodiments, each of the second plurality of actions is an action from the group that consists of: creating the stream, subscribing to the stream, adding a new discussion to the stream, adding a new comment to a discussion in the stream, adding a new comment to a post in the stream, and adding a new post to the stream. Alternatively, according to some such embodiments, each of the second plurality of actions is an action with regard to a stream but not with regard to any individual post within that stream, and each of the second plurality of actions is an action from the group that consists of: creating the stream, subscribing to the stream, adding a new discussion to the stream, and adding a new comment to a discussion in the stream.

Further embodiments of the invention include computer systems that are programmed to carry out one or more of the above methods and computer-readable storage media that are encoded with instructions that, when executed by one or more processors within a computer system, cause the computer system to carry out one or more of these methods.

### BRIEF DESCRIPTION OF THE DRAWINGS

FIG. 1 is a block diagram depicting an exemplary computer system with which embodiments of the invention may at least partially be implemented.

FIG. 2 is a block diagram depicting an exemplary interconnected computer network with which embodiments of the invention may at least partially be implemented.

FIG. 3 depicts an example of a Web page that includes a post to a social networking system according to an embodiment of the invention.

FIG. 4 depicts an example of a Web page that includes a post to a social networking system, to which a user is adding tags, according to an embodiment of the invention.

FIG. 5 depicts an example of a Web page that includes a post to a social networking system, to which a user has added user-specific tags, according to an embodiment of the invention.

FIG. 6 depicts an example of a Web page that includes a listing of posts to a social networking system according to an embodiment of the invention.

FIG. 7 depicts an example of a Web page from which a user may select a topic for filtering posts to be displayed from a social networking system according to an embodiment of the invention.

FIG. 8 depicts an example of a Web page from which a user may select the type of information to be displayed from a social networking system according to an embodiment of the invention.

FIG. 9 depicts an example of a Web page that includes a listing of posts within a stream according to an embodiment of the invention.

FIG. 10 depicts an example of a Web page that includes user comments to a stream according to an embodiment of the invention.

FIG. 11 depicts an example of a Web page that may allow a user to choose what to add to a social networking system according to an embodiment of the invention.

FIG. 12 depicts an example of a Web page that includes a form for creating a post to a social networking system according to an embodiment of the invention.

FIG. 13 depicts an example of a Web page that includes a form for creating a stream maintained by a social networking system according to an embodiment of the invention.

FIG. 14 depicts an example of a Web page that includes a listing of streams maintained by a social networking system according to an embodiment of the invention.

FIG. 15 depicts an example of a Web page that displays a profile of a user of a social networking system according to an embodiment of the invention.

FIG. 16 depicts an example of a Web page that displays a profile of a user of a social networking system according to an embodiment of the invention.

FIG. 17 depicts an example of a Web page that displays a list of users of a social networking system according to an embodiment of the invention.

FIG. 18 depicts a SQL command that selects trending posts according to an embodiment of the invention.

FIG. 19 depicts a SQL command that selects trending streams according to an embodiment of the invention.

FIG. 20 depicts a SQL command that selects recommended streams according to an embodiment of the invention.

FIG. 21 depicts a SQL command that selects recommended posts according to an embodiment of the invention.

FIG. 22 depicts a SQL command that selects recommended users according to an embodiment of the invention.

### DETAILED DESCRIPTION OF PREFERRED EMBODIMENTS

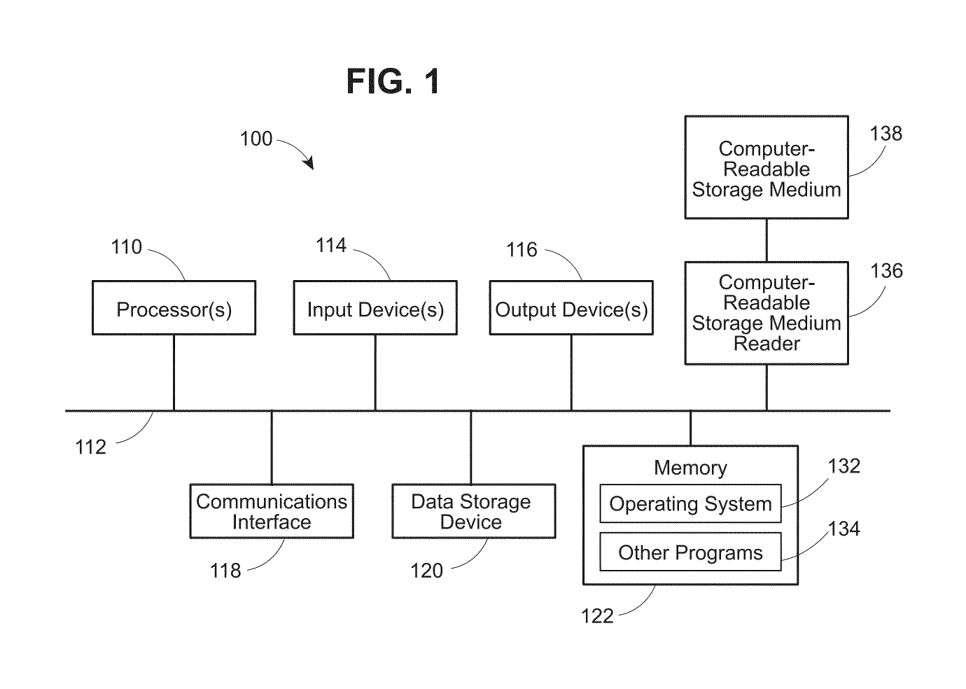

Embodiments of the invention relate to computerized social networking systems, which may be implemented by systems using one or more programmable digital computers. FIG. 1 depicts an example of one such computer system 100, which includes at least one processor 110, such as, e.g., an Intel or Advanced Micro Devices microprocessor, coupled to a communications channel or bus 112. The computer system 100 further includes at least one input device 114 such as, e.g., a keyboard, mouse, touch pad or screen, or other selection or pointing device, at least one output device 116 such as, e.g., an electronic display device, at least one communications interface 118, at least one data storage device 120 such as a magnetic disk or an optical disk, and memory 122 such as ROM and RAM, each coupled to the communications channel 112. The communications interface 118 may be coupled to a network (not depicted) such as the Internet.

Although the computer system 100 is shown in FIG. 1 to have only a single communications channel 112, a person skilled in the relevant arts will recognize that a computer system may have multiple channels (not depicted), including, e.g., one or more busses, and that such channels may be interconnected, e.g., by one or more bridges. In such a configuration, components depicted in FIG. 1 as connected by a single channel 112 may interoperate and may thereby be considered to be coupled to one another, despite being directly connected to different communications channels.

One skilled in the art will recognize that, although the data storage device 120 and memory 122 are depicted as different units, the data storage device 120 and memory 122 can be parts of the same unit or units, and also that the functions of one can be shared in whole or in part by the other, e.g., as RAM disks, virtual memory, etc. It will also be appreciated that any particular computer may have multiple components of a given type, e.g., processors 110, input devices 114, communications interfaces 118, etc.

The data storage device 120 (FIG. 1) and/or memory 122 may store instructions executable by one or more processors or kinds of processors 110, data, or both. Some groups of instructions, possibly grouped with data, may make up one or more programs, which may include an operating system 132 such as, e.g., Microsoft Windows®, Linux®, Mac OS®, or Unix®. Other programs 134 may be stored instead of or in addition to the operating system. It will be appreciated that a computer system may also be implemented on platforms and operating systems other than those mentioned. Any operating system 132 or other program 134, or any part of either, may be written using one or more programming languages such as, e.g., Java®, C, C++, C#, Visual Basic®, VB.NET®, Perl, Ruby, Python, or other programming languages, possibly using object oriented design and/or coding techniques.

One skilled in the art will recognize that the computer system 100 (FIG. 1) may also include additional components and/or systems, such as network connections, additional memory, additional processors, network interfaces, input/output busses, for example. One skilled in the art will also recognize that the programs and data may be received by and stored in the system in alternative ways. For example, a computer-readable storage medium (CRSM) reader 136, such as, e.g., a magnetic disk drive, magneto-optical drive, optical disk drive, or flash drive, may be coupled to the communications channel 112 for reading from a CRSM 138 such as, e.g., a magnetic disk, a magneto-optical disk, an optical disk, or flash memory. Alternatively, one or more CRSM readers may be coupled to the rest of the computer system 100, e.g., through a network interface (not depicted) or a communications interface 118. In any such configuration, however, the computer system 100 may receive programs and/or data via the CRSM reader 136. Further, it will be appreciated that the term “memory” herein is intended to include various types of suitable data storage media, whether permanent or temporary, including among other things the data storage device 120, the memory 122, and the CSRM 138.

As should be apparent, the term “computer-readable storage medium” means a medium that can in fact store information and therefore does not refer to a transitory propagating signal.

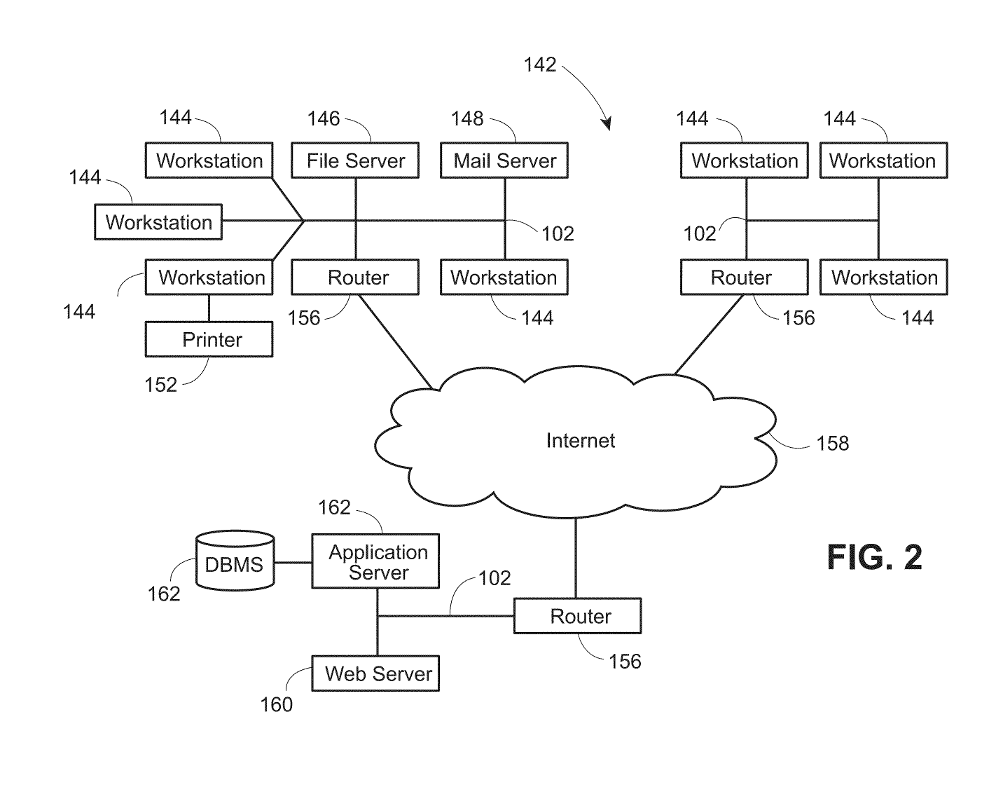

Two or more computer systems 100 (FIG. 1) may communicate, e.g., in one or more networks, via, e.g., their respective communications interfaces 118 and/or network interfaces (not depicted). FIG. 2 is a block diagram depicting an example of one such interconnected network 142. Network 142 may, for example, connect one or more workstations 144 with each other and with other computer systems, such as file servers 146 or mail servers 148. A workstation 144 may comprise a computer system 100. The connection may be achieved tangibly, e.g., via Ethernet® or optical cables, or wirelessly, e.g., through use of modulated microwave signals according to the IEEE 802.11 family of standards. A computer workstation 144 or system 100 that participates in the network may send data to another computer workstation system in the network via the network connection.

One use of a network 142 (FIG. 2) is to enable a computer system to provide services to other computer systems, consume services provided by other computer systems, or both. For example, a file server 146 may provide common storage of files for one or more of the workstations 144 on a network 142. A workstation 144 sends data including a request for a file to the file server 146 via the network 142 and the file server 146 may respond by sending the data from the file back to the requesting workstation 144.

Further, a computer system may simultaneously act as a workstation, a server, and/or a client. For example, as depicted in FIG. 2, a workstation 144 is connected to a printer 152. That workstation 144 may allow users of other workstations on the network 142 to use the printer 152, thereby acting as a print server. At the same time, however, a user may be working at the workstation 144 on a document that is stored on the file server 146.

The network 142 (FIG. 2) may be connected to one or more other networks, e.g., via a router 156. A router 156 may also act as a firewall, monitoring and/or restricting the flow of data to and/or from the network 142 as configured to protect the network. A firewall may alternatively be a separate device (not pictured) from the router 156.

An internet may comprise a network of networks 142 (FIG. 2). The term “the Internet” refers to the worldwide network of interconnected, packet-switched data networks that uses the Internet Protocol (IP) to route and transfer data. For example, a client and server on different networks may communicate via the Internet 158: e.g., a workstation 144 may request a World Wide Web document from a Web server 160. The Web server 160 may process the request and pass it to, e.g., an application server 162. The application server 162 may then conduct further processing, which may include, for example, sending data to and/or receiving data from one or more other data sources. Such a data source may include, e.g., other servers on the same computer system 100 or LAN 102, or a different computer system or LAN and/or a database management system (“DBMS”) 162.

As will be recognized by those skilled in the relevant art, the terms “workstation,” “client,” and “server” are used herein to describe a computer's function in a particular context. A workstation may, for example, be a computer that one or more users work with directly, e.g., through a keyboard and monitor directly coupled to the computer system. A computer system that requests a service through a network is often referred to as a client, and a computer system that provides a service is often referred to as a server. But any particular workstation may be indistinguishable in its hardware, configuration, operating system, and/or other software from a client, server, or both.

The terms “client” and “server” may describe programs and running processes instead of or in addition to their application to computer systems described above. Generally, a software client may consume information and/or computational services provided by a software server.

Embodiments of the invention may use the Web or related technologies. Information may be provided to a user in the form of one or more Web pages. A Web page may include one or more of text, sound, still and moving pictures, and other media, and it may be assembled from one or more files and/or other units accessed from one or more servers and/or other computer systems. Some or all of the content of the page may be generated dynamically, e.g., by one or more servers, and some or all of the content of the page may be generated and/or modified dynamically by the user agent (or browser), e.g., through JavaScript and/or other client-side scripting technologies.

In connection with an embodiment of the invention, a Web site may be implemented using one or more content management systems. For example, a Web site according to an embodiment of the invention may take advantage of the Drupal® content management platform.

The descriptions herein of computers, computer systems, networks, the Internet, and the World Wide Web are intended only for illustration and identification. No such description should be taken to mean that any of those terms is given a meaning other than the ordinary and customary meanings of those terms in the relevant arts.

A social networking system according to an embodiment of the invention may gather, manage, and order information. For example, users of a system according to an embodiment of the invention may provide information that other users may access, and the system may organize the information and control access to it.

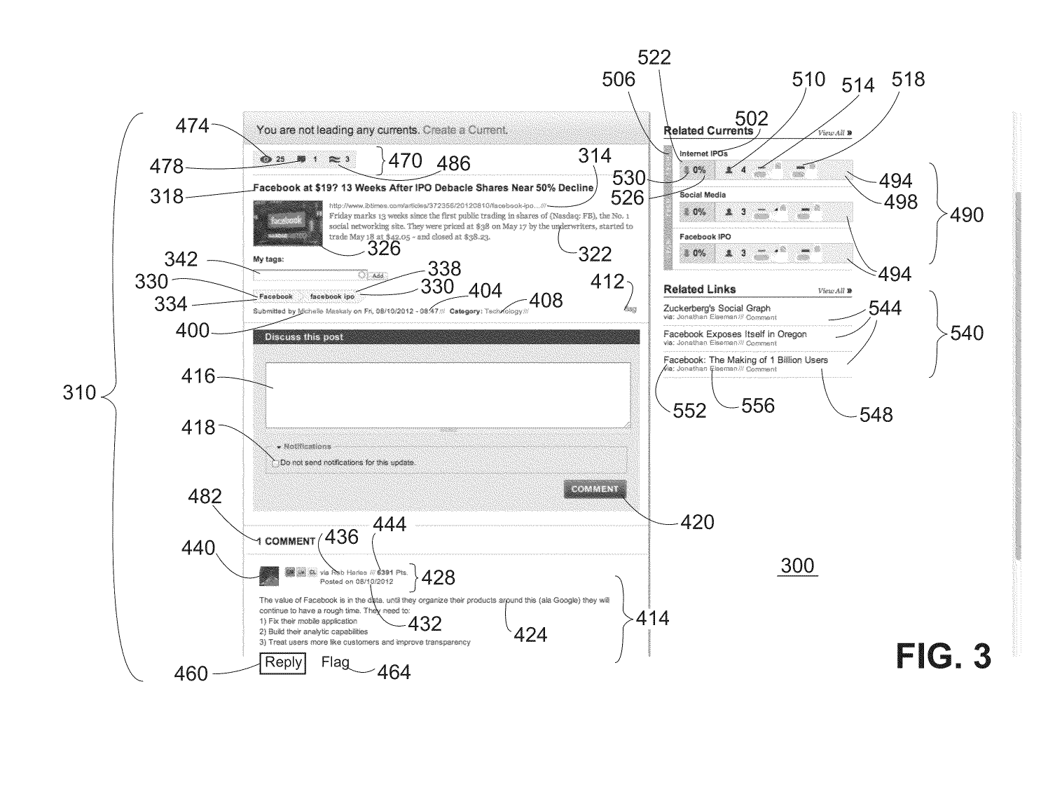

In an embodiment of the invention, the shared information may include “posts” from one or more users. FIG. 3 depicts an example of a Web page 300 (which may be referred to as a “post page”) that includes a post 310 as it may appear in a Web browser. In an embodiment such as FIG. 3 depicts, the post 310 may include, e.g., a hyperlink 314, which may be displayed as the full URL of the target or (as depicted) a shortened version of it. The post 310 may also include user-provided commentary 318 on the material that is the target of the hyperlink. (That material may also be referred to as “the content of the target”, or just “the content” for short.)

Alternatively, in an embodiment of the invention, a post may include, e.g., one or more of: text, audio, video, other media, and interactive material (not pictured) in addition to one or more hyperlinks or instead of them.

As depicted, the post 310 includes a title or headline 318. The title 318 may be supplied by the user who originally made the post 310, or it may be obtained automatically at the time of posting, e.g., as the title of the content or a Web page that contains it. In an embodiment of the invention, the title 318 may also act as a hyperlink to the target of the hyperlink 314.

The post 310 may also in an embodiment of the invention include a description 322. The description 322 may be written by the user who made the post 310, although in embodiments of the invention, it may also be obtained automatically, e.g., by computerized generation of an abstract of the content, retrieval of metadata associated with the content, or otherwise. The description 322 may typically describe the content, analyze or comment on it, or both, but it will be appreciated that as with user-supplied material generally, it may be impractical in connection with a particular embodiment to ensure that the description 322 actually fulfills any of these functions.

In an embodiment of the invention such as FIG. 3 depicts, the post 310 also includes a picture 326 that is associated with the content. The picture 326 may be obtained automatically, e.g., by retrieving an image associated with the content from the page that contains it or an image associated with the site that provides the content. Alternatively, the user may provide the picture 326, e.g., by uploading it or supplying a URL from which the picture may be retrieved.

A post 310 may include one or more tags 330, each of which includes a term or other symbol relevant to the content. For example, when the content is a news article, a tag 330 may be the name of a person or organization who is the subject of the article (“Facebook” 334) or an event related to the article (“facebook ipo” 338). Other examples of tags (not depicted) may include a ticker symbol for a corporation described in the article and a keyword or phrase (e.g., “earnings” or “takeover”). According to embodiments of the invention, a post's tags may be created by one or more users, e.g., at the time of posting as described below, and may therefore include any term or terms that a user may consider relevant to the post.

A tag 330 according to an embodiment of the invention may act as a hyperlink that, when selected, leads, e.g., to a page (not pictured) that presents posts that have the same tag.

According to an embodiment of the invention, a user may add his own tags to another user's post. For example, as FIG. 3 depicts, a page 300 containing a post 310 may include a text entry field 342, in which a user reading a post 310 may enter new tags to be associated with the post 310. In an embodiment of the invention, such user-entered tags (not pictured) may be displayed with the post 310, e.g., in an area 344 directly under the body 310, adjacent to the common tags 326, or adjacent to the text entry field 342. Once entered, in an embodiment, the user-entered tags may be visible only to the user who entered them.

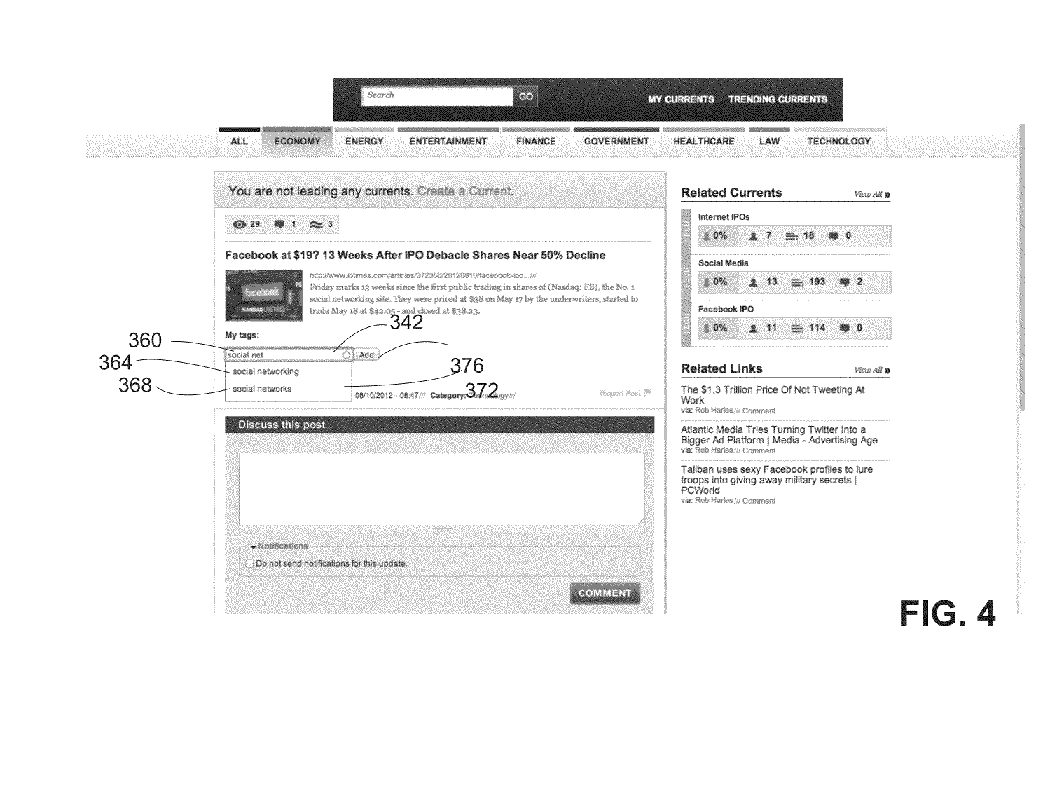

Possibly to check needless proliferation of tags, according to an embodiment of the invention, an autocomplete feature may suggest tags that match text that has been entered in the field 342. For example, as FIG. 4 depicts, a user has entered the text “social net” 360 in the text entry field 342. As the user types, the system may search for tags that this user or others have used previously that include the entered text 360. As FIG. 4 depicts, tags containing “social net” may include, e.g., “social networking” 364 and “social networks” 368, and a drop-down 372 may present any such matches to the user. The user may select one of these suggestions or continue entering text to complete the tag in the field 342. Once the field 342 contains the desired text, the user may add a user-specific tag with that text, e.g., by selecting an “add” button 376 as FIG. 4 depicts.

(Tags are discussed herein in various contexts and in association with various objects. According to embodiments of the invention, an autocomplete feature such as discussed in connection with FIGS. 3-5 may be available in some or all circumstances in which a user may add and/or otherwise modify such tags.)

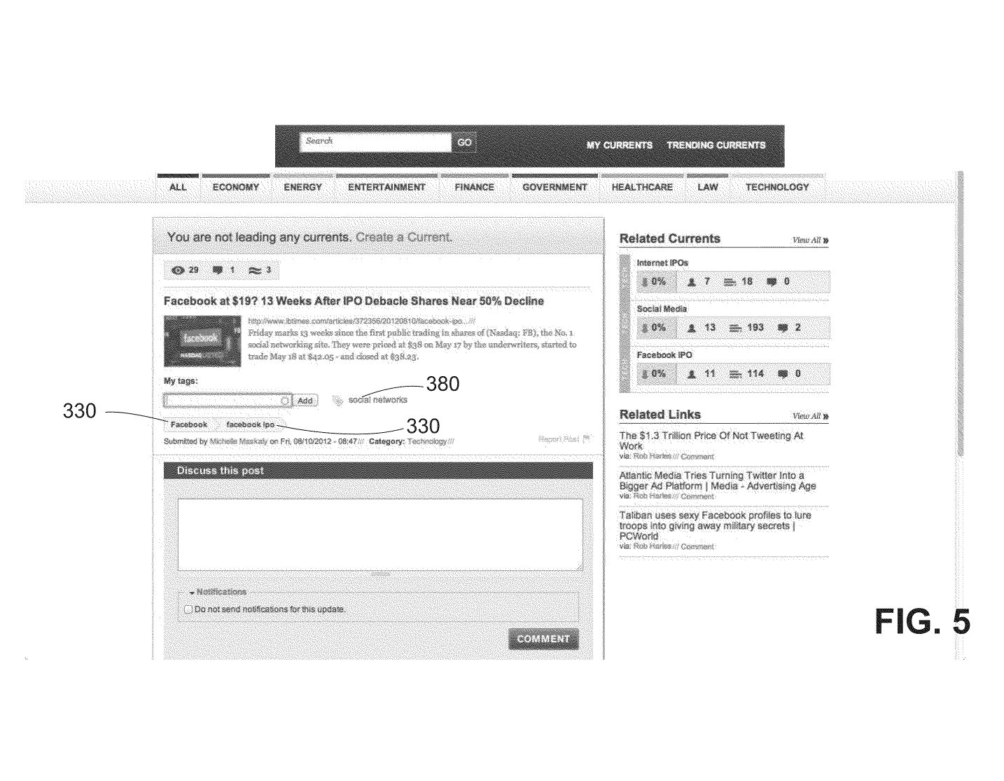

Once entered, the user-specific tag 380 or tags may be displayed, e.g., as FIG. 5 depicts near the other tags 330 but grouped separately from them and/or having a distinct appearance to distinguish the two kinds of tags. A user may in embodiments of the invention be able to edit and/or delete his own user-specific tags.

Returning to FIG. 3, the post 310 may contain information about the user who posted it (the “poster”). For example, in an embodiment of the invention such as FIG. 3 depicts, the post 310 includes the poster's name 400 and the day, date, and time 404 of posting. Depending on the embodiment, the name 400 may be the user's real name and/or some other name and/or symbol that identifies the user. The name 400 may be a hyperlink to additional information about the poster, such as a user profile, for example. (User profiles are discussed further below.)

According to embodiments of the invention, a post 310 may be assigned to one or more categories. If a post 310 is placed in a category, in an embodiment of the invention, the post 310 may include the category name 408. Thus, the post 310 that FIG. 3 depicts is in a category that represents the topic “Technology”. (Categories and categorization of posts and other objects, according to embodiments of the invention, are discussed more fully below.)

A post 310 may include a link 412 and/or other control that allows a user to “flag” a post, which, in an embodiment of the invention, may mean, e.g., reporting the post as inappropriate. The post may then be reviewed, e.g., by an administrator for possible removal. The meaning of “inappropriate” is contextual and may depend, e.g., upon applicable terms of use of the service.

In an embodiment of the invention, users may be able to comment 414 on a post 310. For example, as FIG. 3 depicts, the post page 300 may include a text entry field 416 in which a user may enter a new comment. Depending on the embodiment, a comment may include other content instead of or in addition to text and may include one or more hyperlinks, and an embodiment may provide appropriate user interface elements (not pictured), e.g., to help a user add such other content.

A user may be able to receive notifications upon the occurrence of certain events involving a comment, but the user may disable this feature, e.g., by selecting a checkbox 418.

When the user finishes entering the comment, the user may submit it by selecting the “COMMENT” button 420. In an embodiment of the invention, the comment may be posted immediately after submission. Alternatively, the comment may be subject to moderation, e.g., by the poster, the user who created the stream to which the post belongs, and/or an administrator, and the comment may not appear until and unless a moderator approves it.

As displayed, a comment 414 may include text 424 and a header 428, which may include the date and/or time 432 when the comment was posted. The header 428 may also include information about the commenter, including, e.g., the commenter's name (or username) 436, which may be a hyperlink to the commenter's profile, and the photo or other image 440 that represents the commenter, and which may in an embodiment of the invention also be a hyperlink to the commenter's profile. As described below, a user in an embodiment of the invention may have a score or rating, ranking, or both, and the header 428 may include the score 444 and/or other information.

Just as with the original post, in an embodiment of the invention, it may be possible to reply to a comment. For example, as FIG. 3 depicts, a hyperlink or control 460 may allow a user to post a comment (not pictured) in reply to an existing comment 414, e.g., by causing a text entry field (not pictured) to appear in the browser. When a user makes a comment upon a comment, the poster of the original comment may receive a notification, e.g., by email, unless that post chose to disable notifications, e.g., by selecting the checkbox 418 at the time of commenting. Similarly, a hyperlink or control 464 may allow users to flag a comment as inappropriate.

A post 310 may be displayed with post statistics 470, which, e.g., may have been automatically compiled. For example, in an embodiment of the invention, a post may indicate the number of times it has been viewed 474 and the number of comments 478. As depicted, the number of comments may also appear as a header 482 or other indicator, e.g., above the comments 414 on the post 310.

As discussed elsewhere herein, a post may also be added to one or more groupings called “streams” or (equivalently) “currents”, and the post statistics 470 may include the number of streams 486 that include the post.

According to an embodiment of the invention, a post page 300 and other Web pages may include other information that may be related to the post 310 and/or other content on the page. For example, as FIG. 3 depicts, the post page 300 may include an area 490 with information about streams that may be related to the post 310. The information may take the form of stream summaries 494 that include information about one or more streams. A stream summary 498 may, for example, identify the stream by displaying its title 502 (e.g., “Internet IPOs”). The stream summary 498 may also display the name of a category 506 or topic associated with the stream (e.g., “TECH”, which may be short for “Technology”).

The stream summary 498 may include one or more statistics about the stream. For example, as FIG. 3, depicts, the stream summary 498 indicates the number of users 510 that follow the stream, the number of posts 514 in the stream, and the number of comments 518 in the stream. The stream summary may also indicate 522, e.g., graphically and/or numerically, the amount of recent activity within a stream and/or its recent popularity. For example, as depicted, the stream summary 498 may include a number 526 indicating the “trending percentage” of the stream and an arrow 530 that may indicate, e.g., by color and/or orientation, whether that trend is up or down. In an embodiment of the invention, other information (not pictured) about the absolute and/or relative popularity and/or activity of a stream may be presented, numerically and/or graphically, in addition to or instead of some or all of the foregoing.

A stream summary 498 and/or any one or more of its elements (e.g., the title 502) may be a hyperlink that, when selected, leads to display of the stream and/or information associated with it.

As FIG. 3 depicts, the post page 300 may include an area 540 with information about other posts that may be related to the post 310. The information may take the form of post summaries 544 that include information about one or more posts. For example, a post summary 548 may identify the post by displaying its title 552 (e.g., “Facebook: The Making of 1 Billion Users”). The post summary 548 may also display the name 552 of the poster, and that name 552 may be a hyperlink to additional information about that user. In addition to the forgoing, or instead of it, a post summary 498 and/or any one or more of its elements may be a hyperlink that, when selected, leads to display of that post.

According to embodiments of the invention, posts may be organized in one or more ways and according to one or more criteria and/or attributes. Posts may be stored, retrieved, and/or presented in one or more ways that reflect that organization in whole or in part.

For example, in an embodiment of the invention, posts may be placed into and/or associated with one or more categories, where the categories reflect, e.g., a selection of topics. For example, in an embodiment, the categories may be the topics “Economy”, “Energy”, “Entertainment”, “Finance”, “Government”, “Health Care”, “Law”, and “Technology”. The post 310 that FIG. 3 depicts has been placed in the category “Technology” 352.

Different embodiments may treat categories differently. For example, in an embodiment such as FIG. 3 depicts, every post 310 may be required to be in exactly one category, while in another embodiment, every post 310 may be required to be in at least one category but may be in more than one, and in still another, categorization of a post 310 may be entirely optional. A category name 408 in a post 310 may also be a hyperlink, e.g., to other posts, streams, or both, in that category.

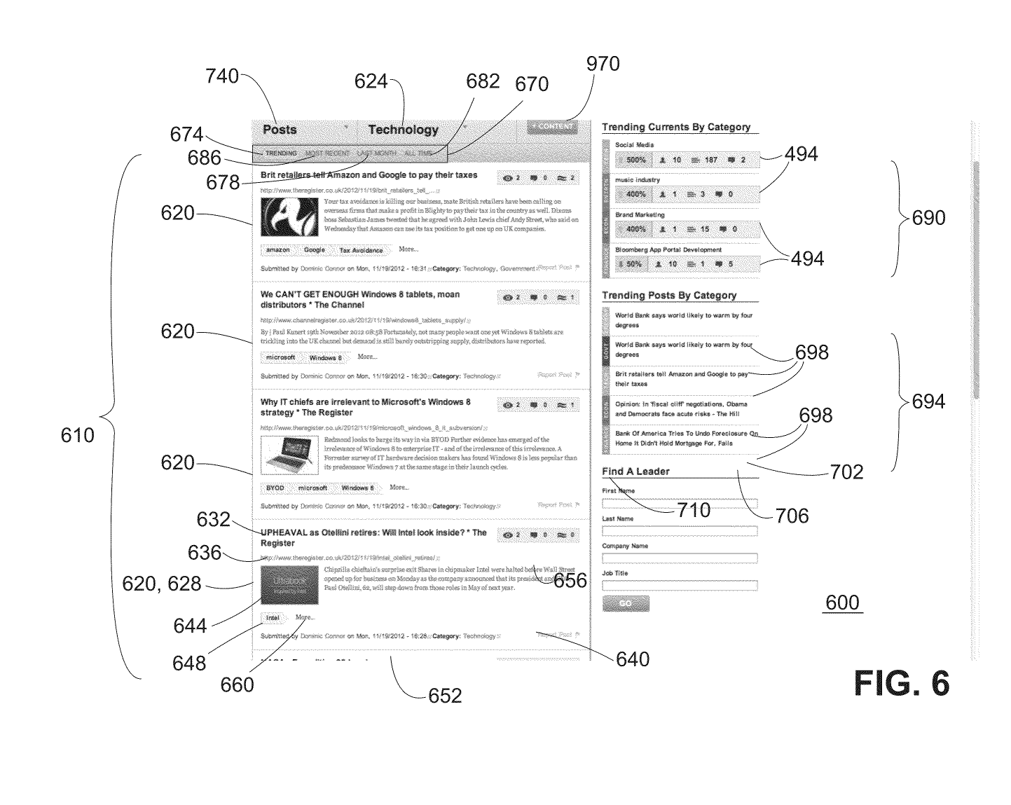

In an embodiment of the invention, a user may choose to view posts by category. FIG. 6 depicts a Web page 600, of a format that may be called a “leaderboard”, which includes a listing 610 of posts 620 that have been associated with the topic “Technology” 624. In the depicted embodiment of the invention, as can be determined by visually comparing FIG. 3 to FIG. 6, a post 628 in a leaderboard page 600 may in some ways resemble a post 310 (FIG. 3) appearing in a post page 300 (FIG. 3). For example, as FIG. 6 depicts, a post 628 in a leaderboard page 600 may include, e.g., a title 632, a full or shortened URL 636 for the post's link, a description 640, a picture 644, one or more tags 648, post information 652, and/or post statistics 656.

Despite the apparent similarities between a standalone post 310 (FIG. 3) and a post 628 in a listing 610 (FIG. 6), elements of a post 628 may differ depending on the page that displays it. For example, in an embodiment of the invention, the headline 632 of the post 628 in a listing 610 may act as a hyperlink to a post page 300 (FIG. 3) that contains just the standalone post 310.

When a post 628 appears as part of a listing 610, e.g., as in FIG. 6, parts of the post may be shortened or otherwise modified to reduce the space needed to display the post 628. For example, the description 640 may be shortened, or comments and/or tags 648 may be omitted, among many other possibilities. In an embodiment of the invention such as is depicted, a hyperlink labeled “More . . . ” 660 may lead to display of the full post, e.g., as FIG. 3 depicts. Moreover, in an embodiment of the invention, the label and hyperlink 660 may be provided for all posts 620 displayed in a listing 610, regardless of whether any individual post 620 or any part of one has actually been abridged.

According to an embodiment of the invention, a user may be able to select from among different criteria for filtering and/or sorting the posts displayed in a listing 610, e.g., as FIG. 6. For example, a leaderboard page 600 presenting posts 620 may include a group of controls and/or hyperlinks 670 (“selectors”) that allow the user to select the ordering in which the posts are displayed and possibly to apply filters. As discussed further below, in an embodiment of the invention, some or all posts may have one or more scores and/or other metrics, which may reflect, e.g., the relative and/or absolute popularity of the posts, and some or all selectors 670 may represent orderings that are based partly or wholly on one or more of these metrics.

For example, in FIG. 6, the posts 620 are sorted in an order that reflects which posts are “trending”, which is reflected by the highlighting of the selector labeled “Trending” 674 from the displayed group of selectors 670. When displayed according to which posts are trending, posts may be ordered within the stream according to their popularity calculated over a relatively short, recent time interval and/or the relative increase in their popularity over such an interval. Calculation of posts' relative popularity according to an embodiment of the invention is discussed in more detail below.

In an embodiment of the invention such as FIG. 6 depicts, other selectors may allow the user to order posts, e.g., according to their popularity based on activity in the last month 678 or on all activity 682 since the respective posts were first posted.

Instead of the above, or in addition to it, a page may include a control such as that labeled “Most Recent” 686, which, when selected, may cause all posts that otherwise qualify for inclusion in the listing 610 to be displayed, e.g., in reverse chronological order, with the most recent post at the top.

According to an embodiment of the invention, the leaderboard page 600 may include information besides the listing 610 of posts 620, and this information may or may not be wholly or partly related to any one or more of the posts 620. For example, as FIG. 6 depicts, a leaderboard page 600 may include an area 690 with information about trending streams, and that may include, e.g., stream summaries 494 for streams that are recently popular.

In an embodiment of the invention, a leaderboard page 600 may include an area 694 with information about trending posts in categories that may not be limited to the selected category 624. The information in this area 694 may take the form, e.g., of one or more summaries 698 of trending posts. A summary 702 may include, e.g., the title 706 of the summarized post and a banner 710 or other indicator of the category (here, “FINANCE”).

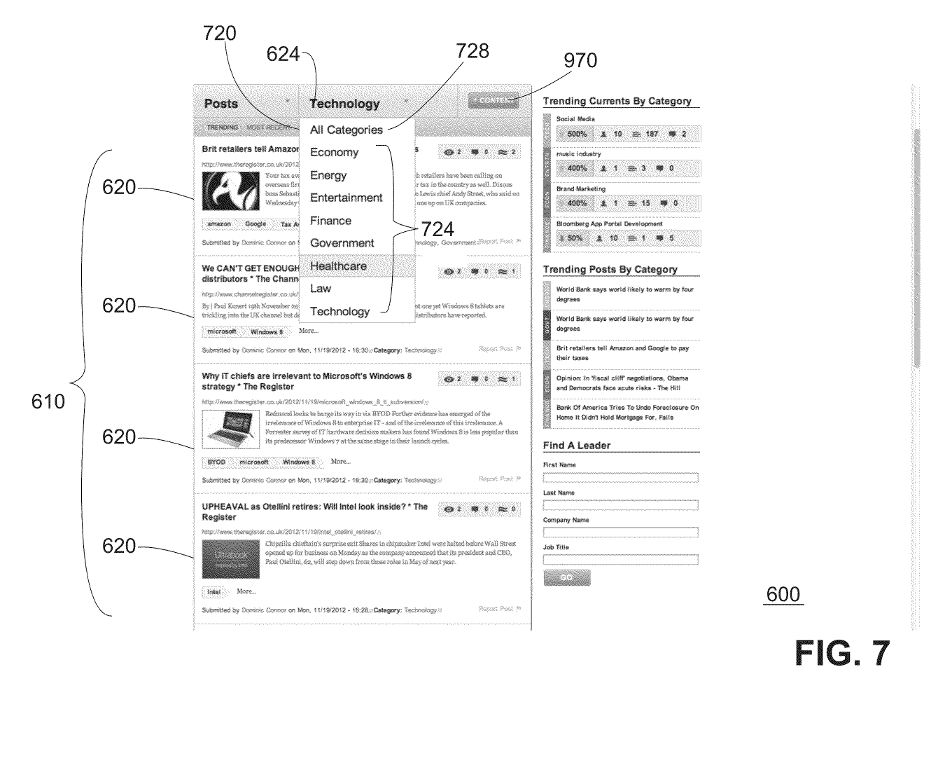

A drop-down that shows the name of the currently selected topic 624 allows the user to change the topic filtering. When the user selects the drop-down 624, a menu 720 (as FIG. 7 depicts) may appear that includes the available topics 724. When the user selects one of the topics 724, the menu may disappear, and the posts 620 may be replaced with other posts (not pictured) that have been associated with the newly-selected topic. In an embodiment of the invention, the menu 720 may include an item such as the depicted “All Categories” 728, which, when selected, may remove any topic filtering and instead cause display of all posts, regardless of topic, according to the ordering and display criteria of the selected sort order.

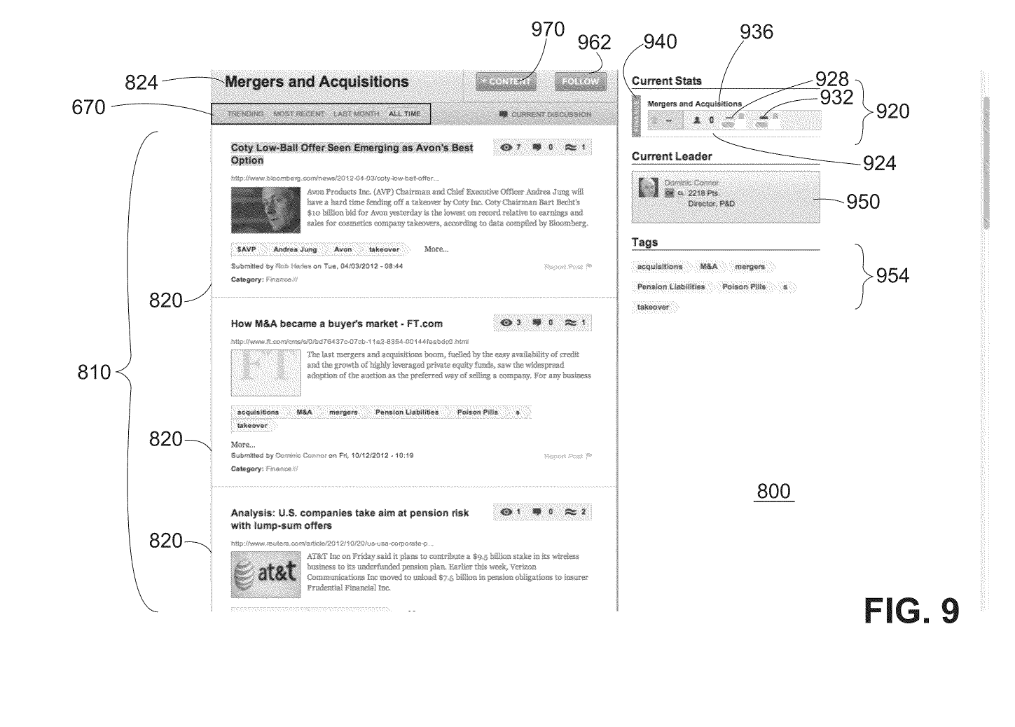

In an embodiment of the invention, the Web page 600 (FIG. 6) may include a drop-down or other control 740 that the user can use to choose to view items other than a list of posts. In an embodiment such as FIG. 6 depicts, the drop-down 740 may identify the class of items currently selected for display. When the user selects the drop-down 740, a menu 750 (as FIG. 9 depicts) may appear that includes the available kinds of display 754 for selection. For example, as depicted, the user may choose between items that designate for display streams 758, posts 762, and people 766.

Instead of abstract categories, topics, or both, or in addition to them, posts according to an embodiment of the invention may be placed in one or more “streams”. A stream, in connection with embodiments of the invention, may be thought of a as a user-curated group or subtopic, although this description is intended merely as an aid to understanding and not as a definition of “stream”.

It is important to note, however, that not every user-created group or subtopic maintained by or in connection with a computerized social networking service, bulletin board service, or other service may be considered a stream, except insofar as it behaves as a stream is further described herein. Further, except as explicitly stated otherwise, the terms “category”, “class”, and “topic”, and related terms (e.g., “subcategory”, “subclass”, “subtopic”, etc.), specifically do not refer herein to streams. Similarly, except as explicitly stated otherwise, placement of a post into a category, class, or topic, other association of a post with a category, class, or topic, and any related term, specifically does not refer herein to placement of a post into a stream or other association of a post with a stream, and placement of a post into a stream or other association of a post with a stream specifically does not refer herein to placement of a post into a category, class, or topic, other association of a post with a category, class, or topic, or any related term.

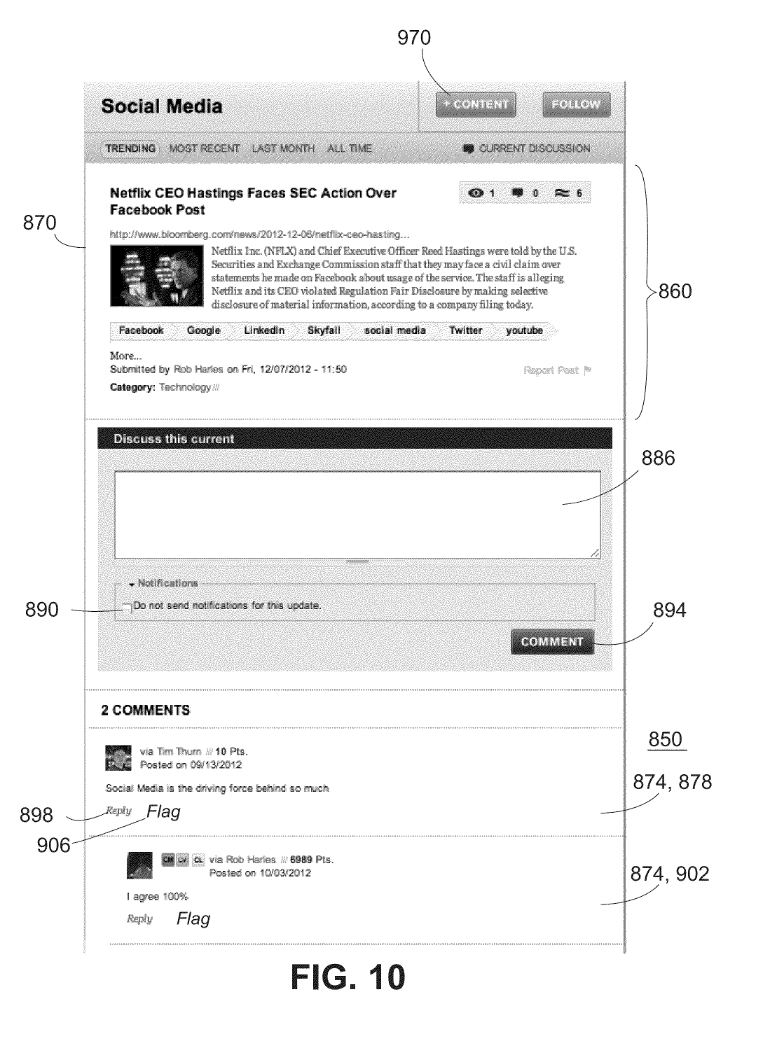

FIG. 9 depicts a Web page 800 that displays a listing 810 of posts 820 within a stream. It will be appreciated that the listing 810 of posts 820 in a stream, according to an embodiment of the invention such as FIG. 10 depicts, may, e.g., take the form of a leaderboard that may resemble a listing 610 (FIG. 6) of posts 620 such as FIGS. 6-8 depict. The stream listing 810 (FIG. 9) may include the selectors 670 to allow the user to choose the order in which the posts 820 appear. The listing may also be accompanied by the title 824 of the stream; e.g., for the depicted stream, the title is “Mergers and Acquisitions”.

In an embodiment of the invention, a user may be able to comment upon a stream, e.g., as users may comment upon individual posts. In an embodiment of the invention, comments upon a stream as a whole, if any, may appear at the bottom of Web pages that list posts in the stream. Such an independent comment thread within a stream may be referred to as a “discussion”.

For example, FIG. 10 depicts a partial Web page 850 that includes a listing 860 of posts 870 from a stream that has two comments 874. (To make room for the comments 874 in the figure, the listing 860 in FIG. 10 includes only a single post 870.) In an embodiment of the invention, a comment 878 upon a stream, e.g., as FIG. 10 depicts, may otherwise appear and/or behave as a comment 414 (FIG. 3) upon a post 310 (FIG. 3).

Returning to FIG. 10, a listing 860 of posts 870 within a stream may include a text entry field 886, in which a user may enter a new comment on the stream. Depending on the embodiment, a comment may include other content instead of or in addition to text and may include one or more hyperlinks, and an embodiment may provide appropriate user interface elements (not pictured), e.g., to help a user add such other content. A user may be able to receive notifications upon the occurrence of certain events involving a comment, but the user may disable this feature, e.g., by selecting a checkbox 890. When the user finishes entering the comment, the user may submit it by selecting the “COMMENT” button 894.

In an embodiment of the invention, the comment may be posted immediately after submission. Alternatively, the comment may be subject to moderation, e.g., by the user who made the original post, the user who created the stream to which the post belongs, and/or an administrator, and the comment may not appear until and unless a moderator approves it.

Just as with the stream as a whole, in an embodiment of the invention, it may be possible to reply to a comment. For example, as FIG. 10 depicts, a hyperlink or control 898 may allow a user to post a comment (not pictured) in reply to an existing comment 878, e.g., by causing a text entry field (not pictured) to appear in the browser.

When one comment relates directly to another comment, and not directly to the underlying stream, the appearance of the comments may in an embodiment of the invention indicate this relationship. For example, as FIG. 10 depicts, the content of a comment 902 is indented to the right relative to the other comment 878 that the first comment 902 is a reply to.

In an embodiment of the invention, comments on a stream may otherwise appear and/or be handled similarly to comments on posts, e.g., with respect to moderation, reporting of abuse, deletion, etc.

When a user makes a comment upon a comment, the poster of the original comment may receive a notification, e.g., by email, unless that poster chose to disable notifications, e.g., by selecting the checkbox 890 at the time of commenting. Similarly, a hyperlink or control 906 may allow users to flag a comment as inappropriate.

A stream listing page 800 may include further information, e.g., about the stream. For example, as FIG. 9 depicts, the page 800 may include summary information 920 about the stream. According to an embodiment of the invention, the summary information may include, e.g., statistics including the number of people who follow the stream 924, the number of posts in the stream 928, and the number of comments in the stream 932. The summary information 920 may also include, e.g., the title of the stream 936 and an indication 940 of the top-level topic that this stream is classified under (here, “Finance”).

The “leader” or (equivalently) “owner” of the stream, who may in an embodiment of the invention be the user who created the stream may be identified, e.g., with information 950 similar to that identifying the creator of a post 400 (FIG. 3) or the information in the header 428 (FIG. 3) of a comment that identifies the commenting user.

A stream listing 810 may also be displayed with some or all tags 954 that are associated with the stream as such. Depending on the embodiment of the invention, the tags 954 that are associated with the stream may or may not be the same as any one or more tags 958 that, e.g., may be associated with any one or more posts 820 in the stream.

A user may be able to follow or subscribe to a stream, which means that the user is able to see, e.g., lists of posts and/or discussions in that stream, and may be able to add posts and/or discussions to the stream. A stream may be public, meaning that all users, even those who do not follow it, are able to see posts and/or discussions in the stream, or private, such that the stream is invisible and/or inaccessible to all users other than its followers.

To follow a stream from a stream listing page 800, in an embodiment of the invention, a user may, e.g., select a control, such as the button 962 labeled “FOLLOW” in FIG. 9. The owner of the stream may then receive a request (not pictured) to allow the user to follow the stream. In response, the owner may accept or reject the request; and in an embodiment of the invention, the owner may be able to allow a user to follow a stream without necessarily allowing the user to add posts to the stream.

A user may be able to add content, which may according to an embodiment of the invention include adding posts to a stream, creating new streams, or both. For example, one or more Web pages may include a button, hyperlink, and/or other control or element, which a user may select to begin adding content. Examples of such an element in an embodiment of the invention may include, among other possibilities, the button labeled “+CONTENT” 970, such as FIGS. 6-10 depict.

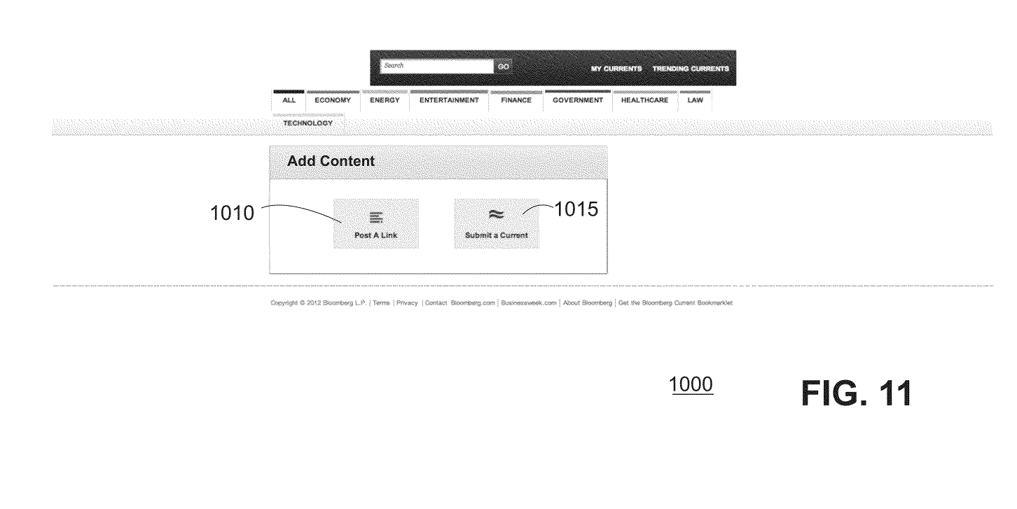

In response to selection of the “+CONTENT” button 970, the user may be presented with selection Web page 1000, e.g., as FIG. 11 depicts. As depicted, the selection Web page 1000 includes two elements: a button labeled “Post a Link” 1010, and one labeled “Submit a Stream” 1015. To post a new link in such an embodiment, the user may select the “Post a Link” button 1010.

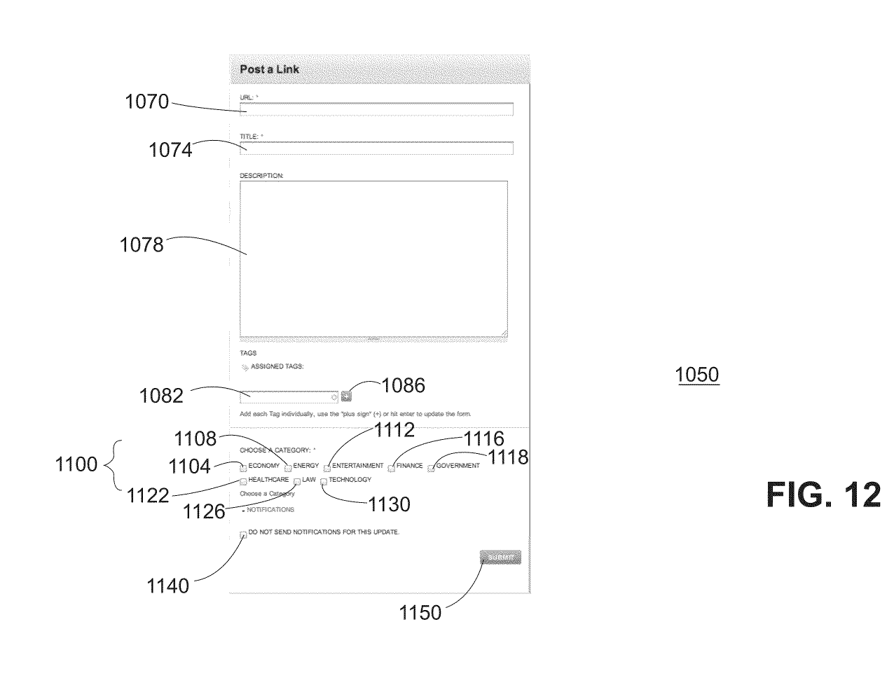

On choosing to create a post, the user may in an embodiment of the invention be presented with a post creation Web page 1050 such as FIG. 12 depicts. Such a page may include, e.g., one or more forms that include text fields and/or other controls that allow the user to enter information that may be displayed with the post. For example, as depicted, the post creation page 1050 includes text fields for the URL 1070 of an article or other resource that the post is to link to, the title 1074 of the post, and a description 1078 of the linked-to resource. Comparing these fields with the post 310 that FIG. 3 depicts, these fields in the depicted embodiment may correspond to the displayed title 318, hyperlink to content 314, and description 322, respectively.

The user may also enter one or more tags to be associated with the post. For example, in an embodiment of the invention such as FIG. 12 depicts, a text entry field 1082 may be provided in which the user may enter a tag. An autocomplete feature may be provided, e.g., as described above, so that as the user types in the tag entry field 1082, a list (not pictured) of one or more tags that match the user's partial entry may appear. The user may continue typing or may select one of the listed tags. Following the user's typing or selection of a tag, the text of the tag may in an embodiment of the invention appear in the tag entry field 1082, and, in an embodiment of the invention, the user may then add the tag to the post by pressing, e.g., the “Enter” or “Return” key on the keyboard or by selecting a control 1086 (here, a button labeled with a plus sign).

In embodiments of the invention, posts may be added to streams automatically, manually, or both. For example, as described above, a stream may have one or more tags associated with it. In an embodiment of the invention, these tags may serve to define the stream, and the system may add posts to one or more streams, possibly without any user intervention, based on the correspondence between the posts' tags and those that define the different streams.

Instead of the foregoing, or in addition to it, in an embodiment of the invention, users may manually associate posts with one or more streams. For example, a user may be able to select one or more streams for the post at the time of posting. In an embodiment of the invention, a user may later add a post to stream, although, depending on the embodiment, this ability may be limited, depending, e.g., on the identities of the user who created the post, the owner of the stream, and the user who seeks to add the post to the stream.

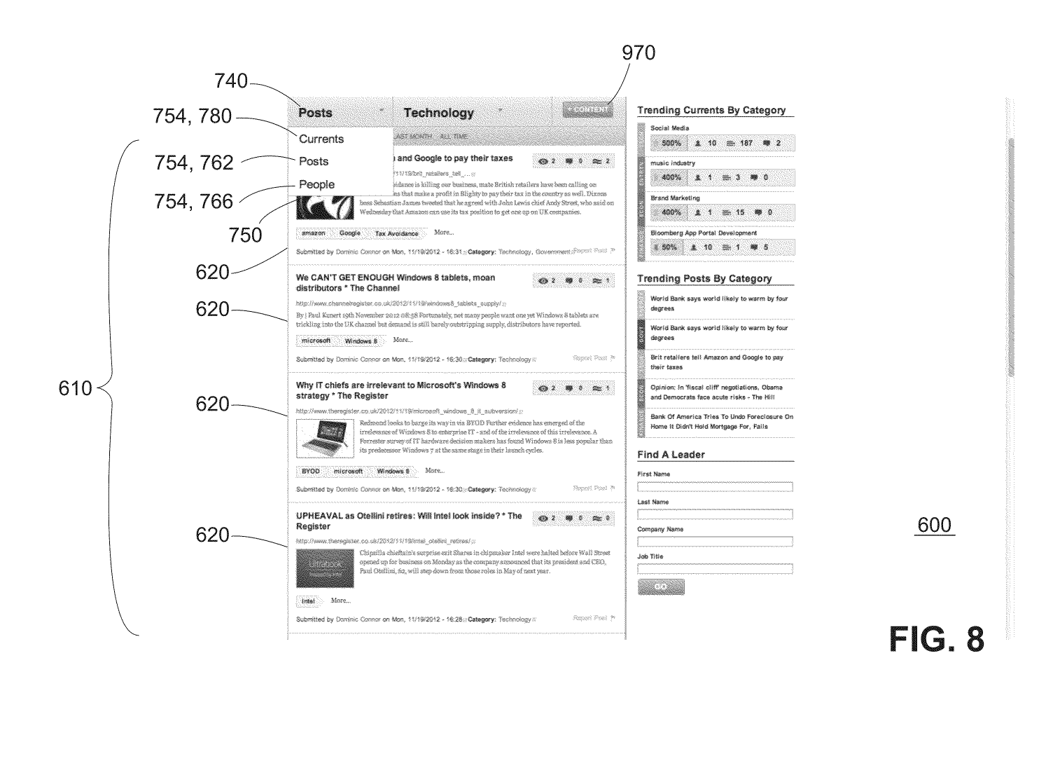

According to embodiments of the invention, it may be possible for the user to associate a post with one or more topics. As FIG. 8 depicts, the form 1050 includes a topic selection region 1100, which includes controls that allow the user to select from among the topics “Economy” 1104, “Energy” 1108, “Entertainment” 1112, “Finance” 1116, “Government” 1120, “Healthcare” 1124, “Law” 1128, and “Technology” 1132.

In the depicted embodiment of the invention, a user must associate a link with exactly one of the topics, but constraints on selecting a topic for a post may vary between embodiments of the invention. For example, in embodiments of the invention, the creator of a post may not be required to associate a post with any topic or topics, but may, depending on the embodiment, be able to associate the post with a single topic or with one or more topics. In other embodiments of the invention, the creator may have to associate the post with at least one topic but may be able to associate the post with more than one of them.

Instead of selection by the user, or in addition to it or in conjunction with it, a post may, in an embodiment of the invention, be automatically associated with one or more topics. This association may, e.g., follow directly from the user's association of the post with one or more streams, each of which may be associated respectively with one or more topics. One or more topics may be associated with the post based on automatic processing of the description entered in the text field 1078 and/or the tags, and/or the posted link, the linked-to content, and/or any metadata associated with the link and/or the content.

In an embodiment of the invention, a user may receive notifications, e.g., when another user leaves a comment on the post. Such a notification may be delivered, e.g., by email and/or any other channel for delivering messages. The poster may be able to control whether such notifications are sent, however, e.g., by selecting or deselecting a control 1140 such as FIG. 12 depicts.

When the user is satisfied with the post, the user may submit it, e.g., by selecting a control such as the button 1150 in FIG. 12 labeled “Submit”.

Returning to the selection page 1000 that FIG. 11 depicts, the user may choose from this page to create a stream instead of a post. To create a stream, the user may, e.g., select the “Submit a Stream” button 1015.

In response to the choice to create a stream, the user may be presented, e.g., with a stream-creation page 1200, such as FIG. 12 depicts. In an embodiment of the invention, the stream-creation page 1200 may comprise a form that allows the user to enter the data for the stream. That form may comprise, for example, a text entry field 1210 for the title of the stream.

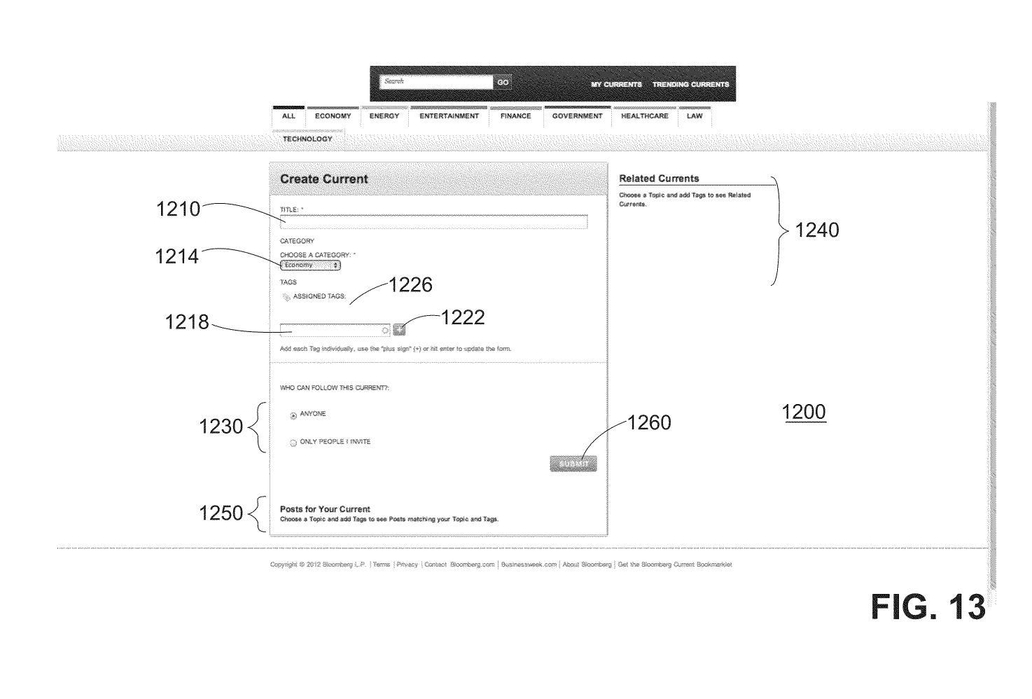

In an embodiment of the invention such as FIG. 13 depicts, in which each stream is associated with exactly one category or topic, the form may comprise a drop-down 1214 from which a user may select the category for the new stream, and when the drop-down 1214 is not selected, it may display the name of the associated category. In another embodiment of the invention that does not impose exactly this rule on the association of categories or topics with streams, appropriate alternative user interface elements (not pictured), such as those well-known in the art, may be provided for topic selection.

The stream-creation page 1200 may include a text field 1218 for the entry of one or more tags. As with other text fields for tag entry, the text field 1218 may support autocomplete as the user types. Once the complete text of a tag is present in the tag entry field 1218, the user may, in an embodiment of the invention such as FIG. 13 depicts, add the tag, e.g., by pressing the “Enter” key or by selecting a button 1222. The stream-creation page may include an area 1226 where tags (not pictured) appear once added to the stream.

In an embodiment of the invention in which tags serve partly or wholly as the basis for assigning posts to streams, a user creating a stream may be required to enter at least one tag.

As discussed above, in an embodiment of the invention, the creator of a stream may be able to restrict access to a stream in whole or in part. For example, in an embodiment such as FIG. 13 depicts, a user may be able to restrict a stream so that only invited users may be able to follow it. Accordingly, the stream-creation page 1200 may include controls such that the user may choose whether the stream will be public or available only by invitation.

One or more facilities may be available, according to an embodiment of the invention, which may help limit the creation of multiple streams that are substantially similar to each other. For example, as FIG. 13 depicts, a stream-creation page 1200 may include an area 1240 for information about streams that may be similar to the stream that the user is creating. For example, as the user selects a topic and enters one or more tags, a system according to an embodiment of the invention may compare the entered information to information about streams that already exist and, in response, may cause the information about similar streams (not pictured) to be updated dynamically. In response, if a user sees that a stream already exists that covers subject matter substantially similar to that the user intends the stream to cover, the user may choose not to finish creating the stream, possibly following one or more previously-created streams instead.

Similarly, in an embodiment of the invention, the user's selection of a topic and tags may be used to identify posts that would be added to the stream if it were to be created with that topic and those tags. Information about some or all of the posts so identified may be displayed, e.g., in a designated area 1250 that is updated dynamically as the user selects the topic and adds, modifies, and removes tags.

When satisfied with the entered information about the stream, the user may create the stream, e.g., by selecting a button such as the depicted “SUBMIT” button 1260. In an embodiment of the invention, any user may create a stream, and submission of the form on the stream-creation page 1200 may cause the immediate creation of the stream. Alternatively, in an embodiment of the invention, creation of a stream may require, e.g., approval by a moderator or other administrative user. In yet another embodiment, some users may be able to create streams directly, while others' streams may require approval before being created.

According to an embodiment of the invention, a user may see information about existing streams, e.g., in a list. For example, when viewing a page such as the page 600 that FIG. 6 depicts, the user may select the drop-down 740, which may cause the list of content types 750 (FIG. 8) to appear. To view a list of streams, the user may select the “Streams” item 758 from the menu 750.

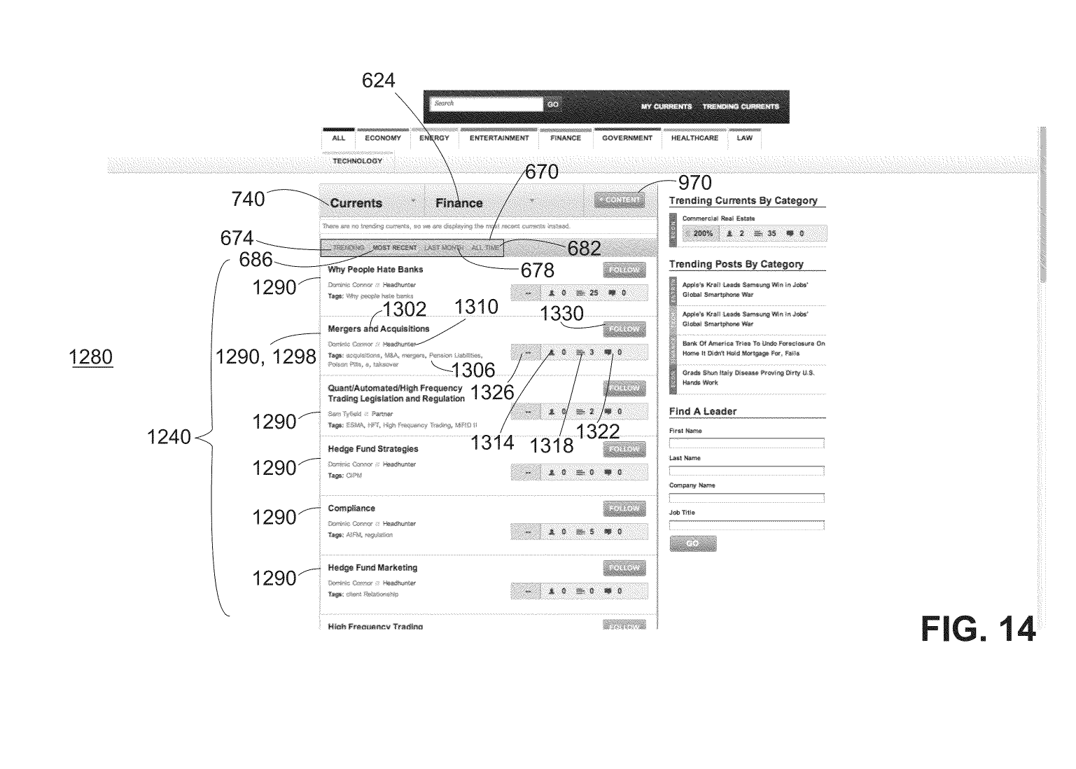

In response, the user may be presented with a stream listing page 1280 such as FIG. 14 depicts. The page 1280 displays information about streams 1290 in the form of a list 1294. As depicted, the topic drop-down 624 indicates that the displayed streams are all associated with the topic “Finance”. In an embodiment such as FIG. 14 depicts, the user may choose to filter streams according to a topic, or to see streams associated with all topics, e.g., by making a selection from the drop-down 624 in the same way that was discussed in connection with FIGS. 6-8.

The stream summaries 1290 that FIG. 14 depicts are displayed in reverse chronological order, which is indicated by the highlighting of the “most recent” selector 686. Depending on the embodiment of the invention, this ordering may depend on the respective streams' creation times; alternatively, a stream may be considered to be as recent as the most recent post that it contains. As yet another alternative, in an embodiment of the invention, the time associated with a stream may be the time of the most recent comment to the stream, to any post within the stream, or both. In embodiments of the invention, any one or more of the foregoing factors may be used, separately or in combination, to determine the ordering of streams that is used when the “most recent” selector 686 has been selected.

In an embodiment as FIG. 14 depicts, the ordering selectors 670 may, e.g., be the same as the selectors 670 that are described in connection with FIG. 6. Thus, streams may be scored, and, depending on the active selector 670, the user may see streams ranked according to those that are trending 674, highest-ranked in the past month 678, or highest-ranked across all time 682. In an embodiment of the invention, the scoring of a stream may depend on the sum of the scores of the posts within the stream, calculated based on the relevant time intervals. Instead of the foregoing, or in addition to it, the score of a stream may depend on the number of times users viewed the stream, e.g., in a Web page 600 such as FIG. 9 depicts. An alternative method of scoring posts is disclosed below.

As the presence of the “trending” selector 674 may indicate, streams in a listing, as with posts in other listings, may in an embodiment of the invention be ordered according to relative increases in popularity. This order is also disclosed more fully below.

In an embodiment of the invention such as FIG. 14 depicts, a stream summary 1298, may include information about the stream, such as, e.g., the name 1302 of the stream and the tags 1306 that define it. The information may also include information about the creator of the stream 1310, including, e.g., the creator's name and/or job title. The stream summary 1298 may also include statistics about the stream, including, for example, the number of people 1314 who follow the stream, the number of posts 1318 in the stream, and the number of comments 1322 that the stream has received. If available, information about whether the stream is trending 1326 may be provided as well.

Some or all information in a stream summary 1298 (such as the name of the stream 1302, for example) may act as a hyperlink, e.g., to a listing of posts in the stream such as FIG. 10 depicts. Instead of or in addition to the foregoing, a user may choose to follow a stream directly from the summary 1298. For example, as depicted, a stream summary 1298 may include a button labeled “FOLLOW” 1330, that a user may select to follow the stream.

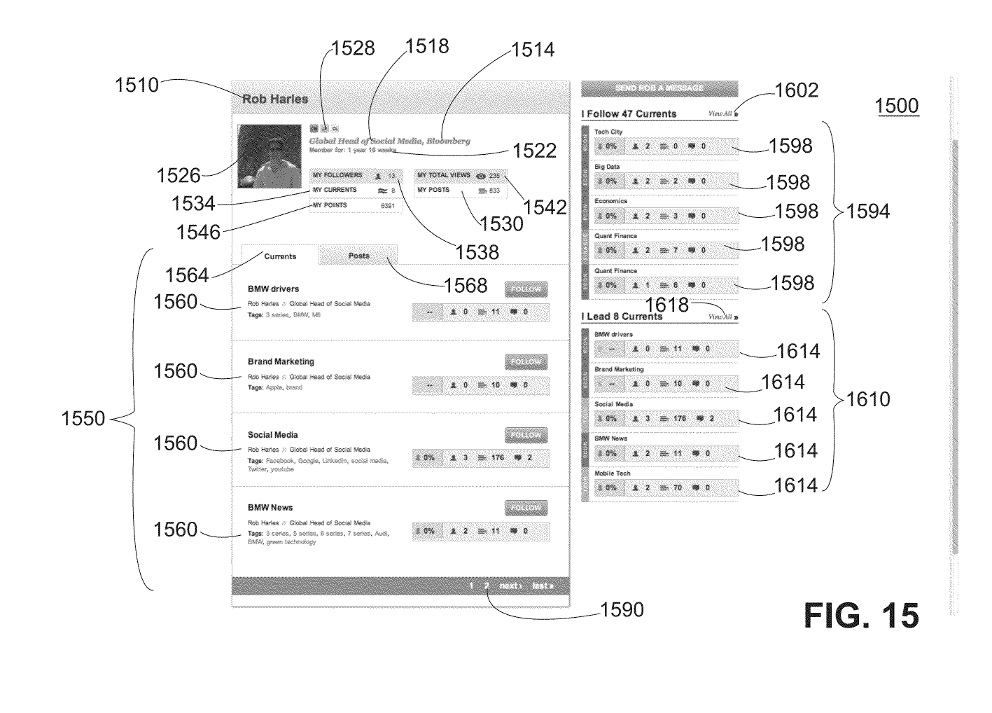

As discussed above, information about users may be available according to an embodiment of the invention. FIG. 15 depicts a user profile Web page 1500 such as may appear in a Web browser according to an embodiment of the invention. The profile page may include information about the profiled user, such as the user's name 1510, the user's employer 1514 and/or job title 1518, and the length of time 1522 that the user has been a member of the service. The profile may include a picture 1526, e.g., of the user or another picture provided by the user.

The profile page 1500 may include statistics about the user, the user's activities, and/or other users' interaction with the user's posts and/or streams. For example, the depicted profile page 1500 includes the number of the user's posts 1530 and the number of the user's streams 1534. The statistics may include those related to the user's popularity and/or influence, such as the number of other users 1538 that follow the user and the total number of times 1542 that the user's posts have been viewed. As discussed below, a user may have a score, which may reflect, e.g., the user's absolute and/or relative popularity, and the profile page 1500 may display that score 1546.

Displayed information about a user may include or otherwise be associated with one or more indicators (e.g., badges) 1528, e.g., on a profile page 1500. Badges 1528 may signify, e.g., the user's roles, status, and/or other achievements.

A profile page 1500 according to an embodiment of the invention may include information about some or all of the user's posts. For example, as depicted, the profile page 1500 includes a list 1550 of summary information about several of the user's streams. In the depicted embodiment, the stream summaries 1560 on a profile page 1500 may resemble the stream summaries 1290 on a stream listing page 1280 as FIG. 14 depicts. Alternatively, in an embodiment of the invention, information on a profile page 1500 (FIG. 15) about a user's streams may differ in substance, appearance, or both, from what FIG. 14 depicts.

The view containing the list 1550 of stream summaries 1560 may be tabbed, e.g., as depicted, and the appearance of the tab 1564 labeled “Streams” may indicate that that tab has been selected. In response to the user's selection of the tab 1568 labeled “Posts”, the profile page 1500 may be modified, e.g., to display information about the user's posts.

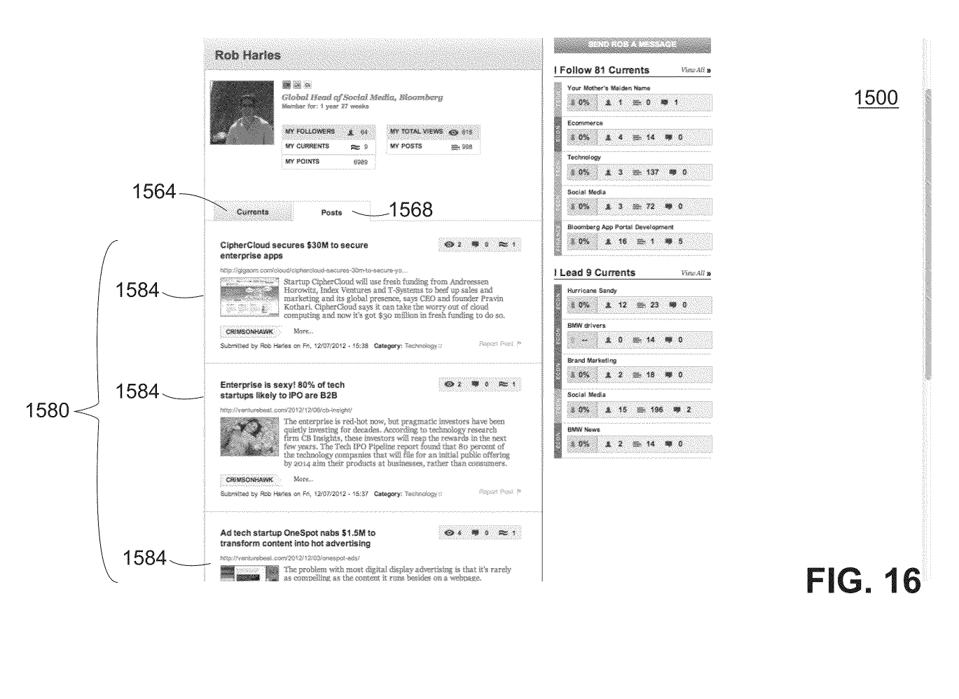

FIG. 16 depicts a profile page 1500 following selection of the “Posts” tab 1568. As depicted, the profile page 1500 now includes a listing 1580 of posts 1584. In an embodiment of the invention such as FIG. 16 depicts, the post summaries 1584 on a profile page 1500 may resemble the post summaries 620 (FIG. 6), e.g., on a leaderboard page 600 such as FIG. 6 depicts. Alternatively, in an embodiment of the invention, information on a profile page 1500 (FIG. 16) about a user's streams may differ in substance, appearance, or both, from what FIG. 16 depicts.

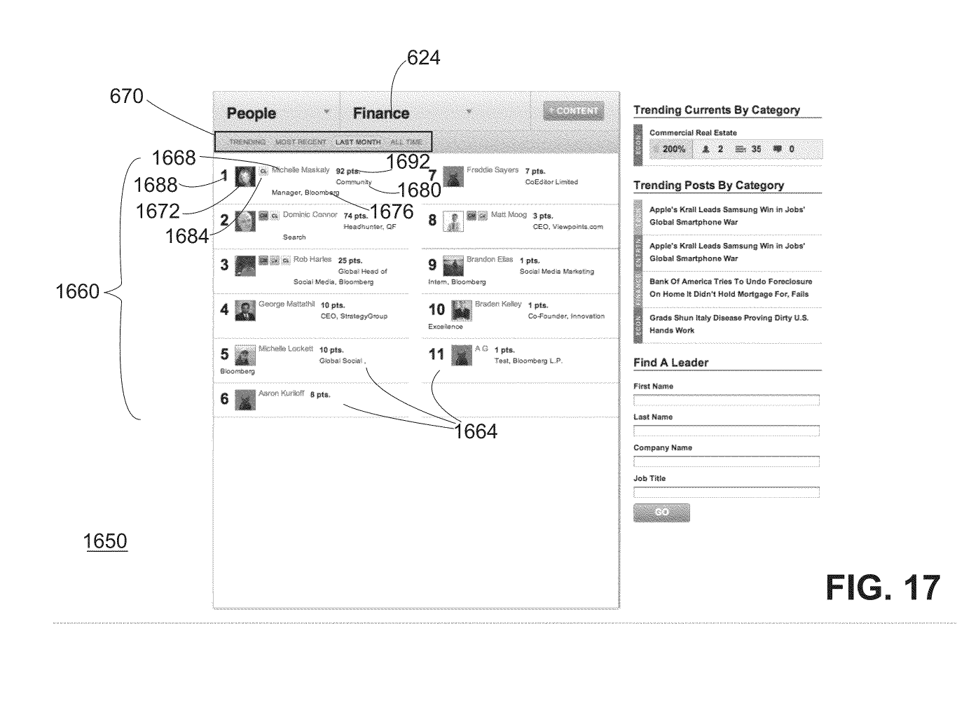

A user may have created more posts, streams, or both, than may comfortably fit on a profile page 1500. To manage the length of the profile page 1500, in an embodiment of the invention, the list of streams 1550 (FIG. 15), the list of posts (FIG. 16), or both, may be, e.g., paged if the listing exceeds a certain length. For example, as FIG. 17 depicts, the list of streams 1550 may be accompanied by one or more controls, hyperlinks, and/or other user interface elements, e.g., as are known in the art for traversing paged lists.

According to an embodiment of the invention, a profile page 1500 may include other information in addition to, or instead of, some or all of the foregoing. For example, as FIG. 15 depicts, the profile page 1500 includes an area 1594 for information that identifies one or more streams that the user follows. The information may take the form, e.g., of one or more stream summaries 1598, such as described elsewhere herein. Because the user may follow more streams than can be listed in the desired space, the area 1594 may include a hyperlink 1602 and/or other elements, e.g., to a page (not pictured) that directly or indirectly provides information about all of the stream that the user follows.

Similarly, in an embodiment of the invention, the profile page 1500 may include an area 1610 for information that identifies one or more streams that the user has created. The information may also take the form, e.g., of one or more stream summaries 1614, such as described elsewhere herein. Because the user may have created more streams than can be listed in the desired space, the area 1610 may include a hyperlink 1618 and/or other elements, e.g., to a page (not pictured) that directly or indirectly provides information about all of the user's streams.

A Web site according to an embodiment of the invention may make information about users available, e.g., in a listing and/or other directory. FIG. 17 depicts a user listing page 1650, which includes a listing 1660 of users in the form of a leaderboard.

As depicted, the listing 1660 is made up of summaries 1664 that represent the users. For example, each summary 1664 may include information about the represented user, such as the user's name 1668, a picture 1672, the user's employer 1676 and/or job title 1680, and one or more badges 1684. Some or all of this information may be the same as the corresponding information about the user that the profile page 1500 (FIG. 15) presents or may be related to it.

Consistent with the description of the format as a “leaderboard”, the listing 1660 (FIG. 17) may reflect a ranking of the users. In such a display, a user summary 1664 may also include a number 1688 and/or other indication of each user's ranking. The summary 1664 may also indicate, e.g., a numeric score 1692 that the rankings are based on.

As with other pages discussed above (e.g., FIG. 6), a user listing page 1650 according to an embodiment of the invention may include one or more selectors 670 that allow the user to modify the basis of the ranking and/or to apply filters. The page 1650 may also include, e.g., a drop-down 624 that may be used to apply a topic or category filter. In response to a user's choice of a new topic using the drop-down 624 and/or a new selector 670, the list of users may be reordered to reflect the new selection. Further, in an embodiment of the invention, the users' respective scores 1692 may reflect only posts that meet the selected criteria: for example, as depicted, the user's scores reflect only their posts that have been categorized under “Finance”, but if the topic is changed from “Finance” to “Technology”, each user's score may reflect only their posts in the category “Technology” and/or their discussions in streams within that category.

As described elsewhere, embodiments of the invention may display information that implicitly or explicitly reflects evaluations of, e.g., posts, streams, or users, for example, by listing these objects in a user-selected order. For example, a Web page may list posts or streams in the form of a leaderboard, which orders the presented objects according to a score. A Web page may also display recommended posts, streams, or users, and such a recommendation may reflect, e.g., an algorithmic evaluation of the recommended objects as potentially interesting to the user.

According to an embodiment of the invention, an object—such as a stream, a post, a discussion, or a user, for example—may receive points as people use the system. Over time, these points may accumulate into one or more scores for various purposes, and the computation of one or more of these scores may also take into account, e.g., the elapsed time since the scored event.

For example, in an embodiment of the invention, a post may receive a numeric value upon it creation. Users' actions, such as adding the post to streams, adding comments to the post, following a link in a post to a source article, and sharing the post, may increase the post's score. In an embodiment of the invention, the effects of these actions may be such as in Table 1.

TABLE I
Effects of Actions on Posts' Scores

| Activity | Point Value |
|---|---|
| (Initial Score) | 10 |
| New share via social media | 4 |
| (e.g., Twitter, Facebook) | |
| New click on source link | 3 |
| New comment to post | 3 |
| Post is added to a new stream | 2 |

As discussed above, in an embodiment of the invention, a Web page may display items, such as posts, listing them in order of their relative popularity over a specified time period. For example, when viewing a Web page 600 such as FIG. 6 depicts, a user may specify a time period by choosing the appropriate selector 670. In such an embodiment, choosing the selector labeled “last month” 678 may cause ordering of the posts according to the respective numbers of points each post received in the past 30 days, while choosing the selector labeled “most recent” 686 may cause ordering according to the points received in the past 24 hours. The selector labeled “all time” 682 may cause ordering according to the raw numbers of points received regardless of time.

Also as discussed above, a leaderboard may include a selector 674 that causes ordering of posts according to which ones are “trending”. In an embodiment of the invention, a post may have a separate score, the “trending score” or “trending value” that places a relatively heavier weight on recent actions without necessarily disregarding older ones.

For example, in an embodiment of the invention, the trending score may increase, e.g., by the values in Table 1 upon occurrence of the specified events. The trending score may then be periodically reduced, e.g., by a specified percentage. For example, every 24 hours, a process may reduce all posts' trending scores by half.

For example, a post in such an embodiment may have a trending score of 10 points immediately upon its creation. During the first day, the post may be receive 10 comments, each of which (reflecting Table 1) adds 3 points, so that, just before the end of the first day, the post has a trending score of 40 points. At the end of the first day, however, the trending score is halved, to 20 twenty points.

To continue the example, during the second day, the post may be shared twice via other social media, receiving 4 points for each share (and 8 points total). The source link may be followed 3 times, for a total of 9 more points, and the post may receive 2 more comments, adding another 6 points. Just before the end of the second day, the trending score would be 20+8+9+6=43 points. At the end of the second day, the trending score would be halved again, to 21.5 points.

According to an embodiment of the invention, for the sake of efficiency, every post may have its score reduced at the same time (or roughly so, accounting for the time needed to update multiple records).

Other objects, e.g., streams, discussions, and users, may be scored similarly in an embodiment of the invention. Table 2 lists actions that may give points to discussions and the number of points assigned to each, according to an embodiment of the invention. Table 3 provides the corresponding information for streams.

TABLE 2
Effects of Actions on Discussions' Scores

| Activity | Point Value |
|---|---|
| (Initial Score) | 15 |
| New comment is added to | 3 |
| discussion | |

TABLE 3
Effects of Actions on Streams' Scores

| Activity | Point Value |
|---|---|
| (Initial Score) | 10 |
| New subscriber to stream | 4 |
| New discussion added to stream | 4 |
| Comment added to a post in the | 3 |
| stream | |
| Comment added to a discussion | 3 |
| in the stream | |
| New post is added to the stream | 1 |

People may have scores as well in embodiments of the invention. For example, when a stream, discussion, or post receives points as above, the user who created that object may receive the same number of points. In an embodiment of the invention, however, a user's score may not decay, e.g., in the manner described above for streams′, discussions′, and posts' trending scores.

(The discussion of scoring algorithms herein and particular point values associated with actions and/or scoring is meant solely to illustrate one embodiment of the invention and is not in any way limiting.)

Embodiments of the invention may take advantage of one or more software frameworks. For example, an embodiment of the invention may be implemented using the Drupal content management system, which in turn may use a Web server (such as Apache) and a database management system, which may be a relational database management system (RDBMS) such as MySQL. In such an embodiment, scoring information may be stored, e.g., in one or more tables within the RDBMS, and such a table may be referred to herein as a “trending table”.

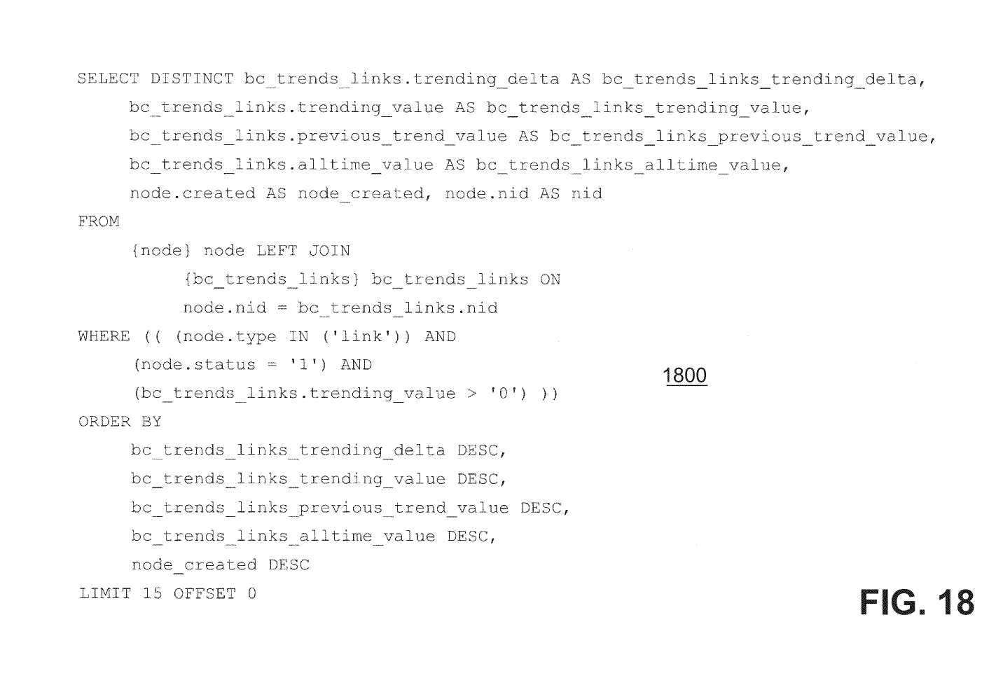

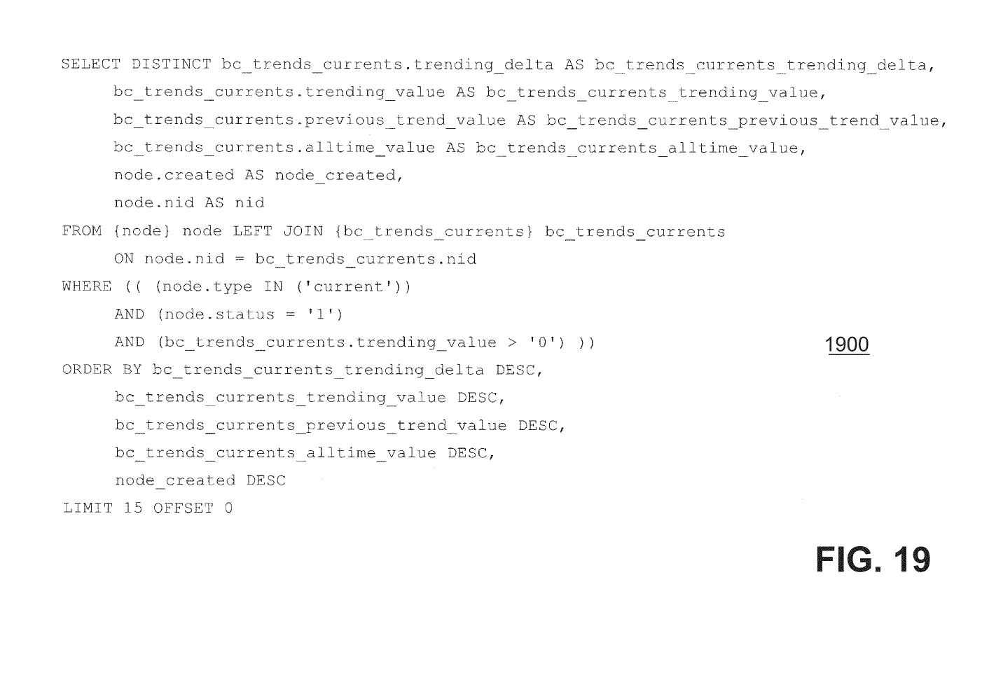

FIG. 18 depicts a SQL command 1800 to select trending posts according to an embodiment of the invention that uses Drupal. In that embodiment, an RDBMS contains a trending table for posts, which is named “bc_trends_links”. Similarly, FIG. 19 depicts a SQL command 1900 to select trending streams according to an embodiment of the invention in which the RDBMS contains a trending table for streams, which is named “bc_trends_currents”.

In such an embodiment, a SQL command for selecting trending users may be similar, although it will be appreciated that the command may be more complex if, as discussed above, a user's score depends, e.g., on the separate scores for the users posts, streams, and discussions.

In an embodiment of the invention, one or more trending tables may also be used in algorithmically selecting related or recommended posts, streams, or other objects. For example, as FIG. 3 depicts, a page may include an area 490 with information about streams (also referred to as currents) that may be related to a currently-displayed post, stream, or discussion. To select such related streams, a system according to an embodiment of the invention may, e.g., select streams with relatively high trending scores that have the same category as the displayed stream, post, or discussion. To vary the display, a system may, e.g., randomly select for display streams from among the highest-scoring streams, rather than simply displaying the highest-scoring streams.

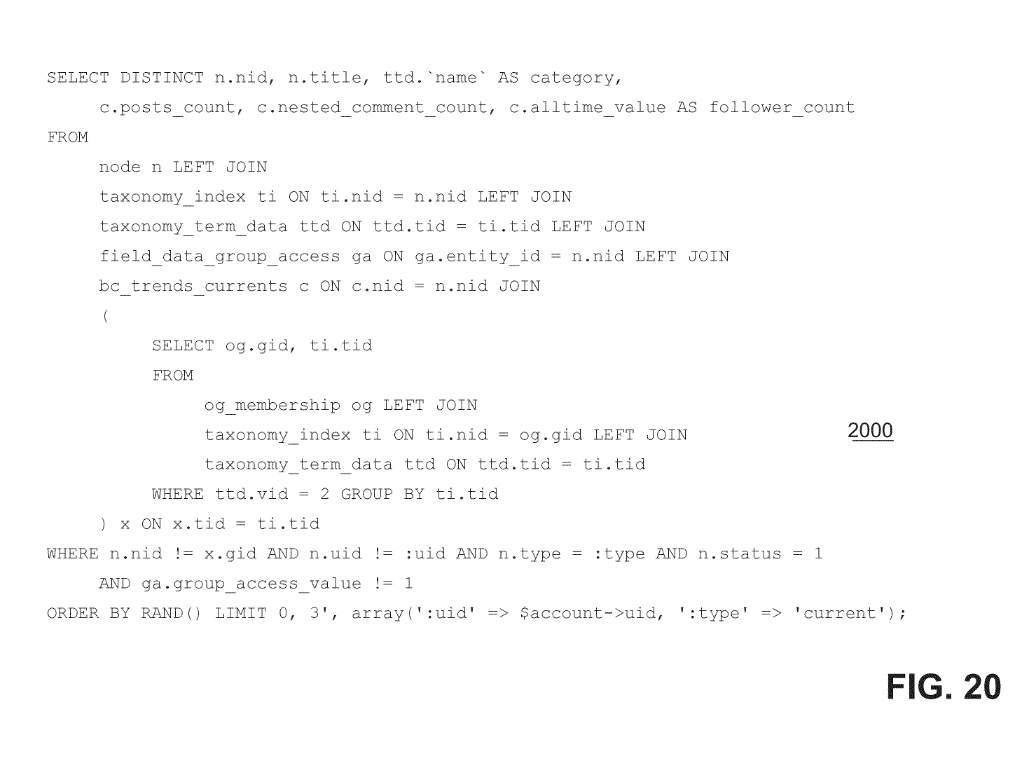

Instead of displaying “related” streams, or in addition to doing so, a system according to an embodiment of the invention may in some contexts recommend streams based on the user's activity. For example, according to an embodiment of the invention, a system may select for recommendation streams with high trending scores in categories in which the user leads or subscribes to streams. FIG. 20 depicts a SQL command 2000 to select such streams for recommendation according to a system implemented using Drupal (with the optional “Organic groups” module) and MySQL, with trending data in a table called “bc_trends_currents”.

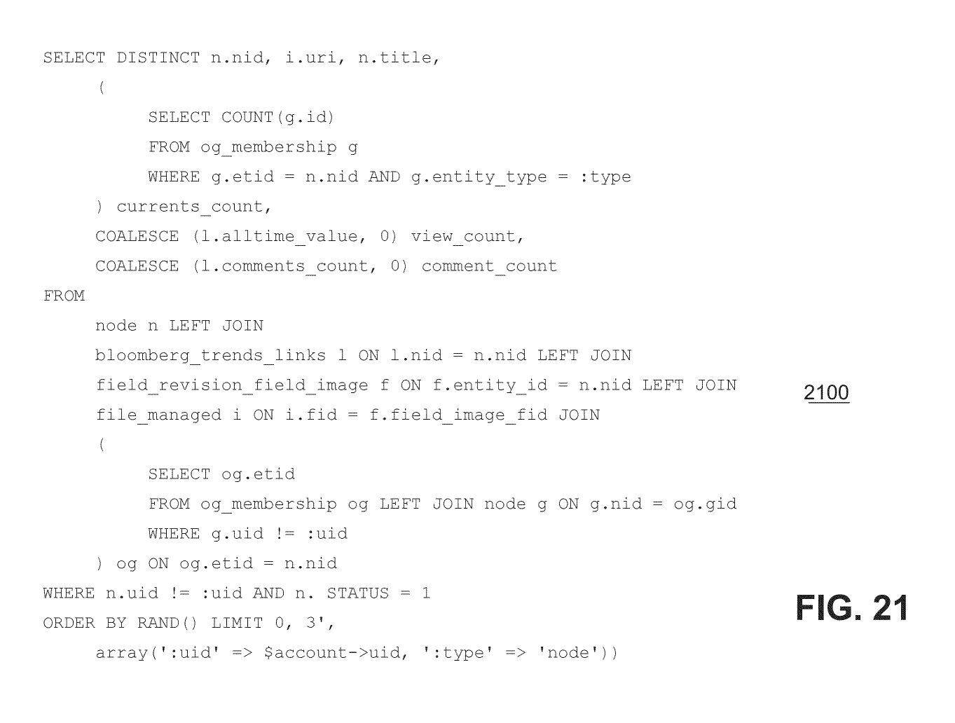

According to an embodiment of the invention, posts may similarly be recommended and/or identified as relevant. FIG. 21 depicts a SQL command 2100 to select such posts for recommendation according to a system that has trending data in a table called “bc_trends_posts”.

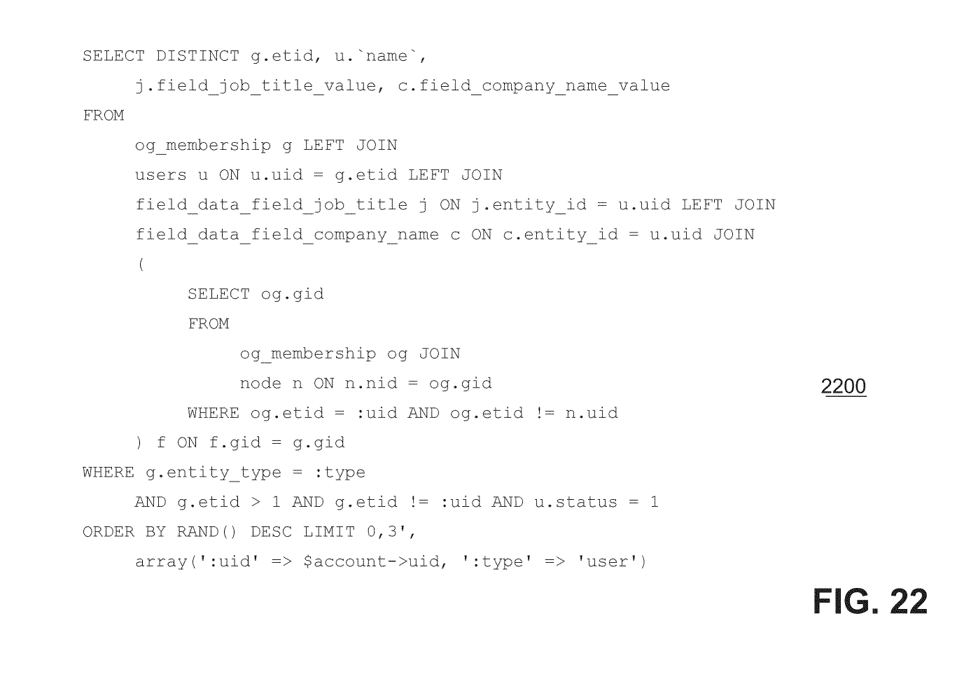

An embodiment of the invention may also include recommendations of users based, e.g., on user affiliations. Such affiliations may include, for example, both affiliations independent of the social networking application (e.g., employment by the same entity) and affiliations within the application (e.g., subscription to the same streams). To avoid constantly recommending the same users, selection may be partially randomized among users who share such affiliations. FIG. 22 depicts a SQL command 2200 to determine recommended people according to an implementation such as discussed above.

1. A method of providing information, the method being performed by a networked computer system that comprises one or more processors, one or more interfaces operatively coupled to one or more of the processors, and one or more databases operatively coupled to one or more of the processors, the method comprising:
storing in the database information that represents a plurality of streams, information that represents a plurality of posts, and, for each post, information that specifically associates that post respectively with at least one of the streams;
receiving through at least one of the interfaces first user input corresponding to a first plurality of actions, performed by at least one user, with regard to the plurality of posts;
at least one of the processors executing instructions to calculate, for each of the streams, a score for the stream based upon the first user input;
for each stream, storing the respective score for that stream in the database in association with the stream;
at least one of the processors calculating an ordering for a plurality of the streams based on the scores of the streams; and
transmitting through at least one of the interfaces information that indicates the ordering.

2. The method of claim 1, wherein each of the first plurality of actions is an action from the group that consists of: creating the post, sharing the post via social media, following a hyperlink within the post, adding a new comment to the post, and adding the post to a new stream.

3. The method of claim 1, comprising:
receiving through at least one of the interfaces second user input corresponding to a second plurality of actions, performed by at least one user, with regard to the plurality of streams;
wherein the calculated score for each stream is based on the first user input and the second user input.

4. The method of claim 3, wherein each of the second plurality of actions is an action from the group that consists of: creating the stream, subscribing to the stream, adding a new discussion to the stream, adding a new comment to a discussion in the stream, adding a new comment to a post in the stream, and adding a new post to the stream.

5. The method of claim 3, wherein:
each of the second plurality of actions is an action with regard to a stream but not with regard to any individual post within that stream; and
each of the second plurality of actions is an action from the group that consists of: creating the stream, subscribing to the stream, adding a new discussion to the stream, and adding a new comment to a discussion in the stream.

6. A networked computer system for providing information, the computer system comprising one or more processors, one or more interfaces operatively coupled to one or more of the processors, one or more databases operatively coupled to one or more of the processors, and a computer-readable storage medium operatively coupled to one or more of the processors and encoded with instructions that, when executed by at least one of the processors, cause the computer system at least to:
store in the database information that represents a plurality of streams, information that represents a plurality of posts, and, for each post,
information that specifically associates that post respectively with at least one of the streams;
receive through at least one of the interfaces first user input corresponding to a first plurality of actions, performed by at least one user, with regard to the plurality of posts;
execute instructions to calculate, for each of the streams, a score for the stream based upon the first user input;
for each stream, store the respective score for that stream in the database in association with the stream;
calculate an ordering for a plurality of the streams based on the scores of the streams; and
transmit through at least one of the interfaces information that indicates the ordering.

7. The computer system of claim 6, wherein each of the first plurality of actions is an action from the group that consists of: creating the post, sharing the post via social media, following a hyperlink within the post, adding a new comment to the post, and adding the post to a new stream.

8. The computer system of claim 6, wherein the instructions comprise instructions that, when executed by at least one of the processors, cause the computer system at least to receive through at least one of the interfaces second user input corresponding to a second plurality of actions, performed by at least one user, with regard to the plurality of streams; wherein the calculated score for each stream is based on the first user input and the second user input.

9. The computer system of claim 8, wherein each of the second plurality of actions is an action from the group that consists of: creating the stream, subscribing to the stream, adding a new discussion to the stream, adding a new comment to a discussion in the stream, adding a new comment to a post in the stream, and adding a new post to the stream.

10. The computer system of claim 8, wherein:
each of the second plurality of actions is an action with regard to a stream but not with regard to any individual post within that stream; and
each of the second plurality of actions is an action from the group that consists of: creating the stream, subscribing to the stream, adding a new discussion to the stream, and adding a new comment to a discussion in the stream.

11. A computer-readable storage medium encoded with instructions that, when executed by at least one processor within a computer system that comprises one or more processors, one or more interfaces operatively coupled to one or more of the processors, and one or more databases operatively coupled to one or more of the processors, cause the computer system at least to:
store in the database information that represents a plurality of streams, information that represents a plurality of posts, and, for each post, information that specifically associates that post respectively with at least one of the streams;
receive through at least one of the interfaces first user input corresponding to a first plurality of actions, performed by at least one user, with regard to the plurality of posts;
execute instructions to calculate, for each of the streams, a score for the stream based upon the first user input;
for each stream, store the respective score for that stream in the database in association with the stream;
calculate an ordering for a plurality of the streams based on the scores of the streams; and
transmit through at least one of the interfaces information that indicates the ordering.

12. The computer-readable storage medium of claim 11, wherein each of the first plurality of actions is an action from the group that consists of: creating the post, sharing the post via social media, following a hyperlink within the post, adding a new comment to the post, and adding the post to a new stream.

13. The computer system of claim 11, wherein the instructions comprise instructions that, when executed by at least one of the processors, cause the computer system at least to receive through at least one of the interfaces second user input corresponding to a second plurality of actions, performed by at least one user, with regard to the plurality of streams; wherein the calculated score for each stream is based on the first user input and the second user input.

14. The computer system of claim 13, wherein each of the second plurality of actions is an action from the group that consists of: creating the stream, subscribing to the stream, adding a new discussion to the stream, adding a new comment to a discussion in the stream, adding a new comment to a post in the stream, and adding a new post to the stream.

15. The computer system of claim 13, wherein:
each of the second plurality of actions is an action with regard to a stream but not with regard to any individual post within that stream; and
each of the second plurality of actions is an action from the group that consists of: creating the stream, subscribing to the stream, adding a new discussion to the stream, and adding a new comment to a discussion in the stream.
